(19) United States
(12) Patent Application Publication
(10) Pub. No.: US 2018/0216052 A1
(43) Pub. Date: Aug. 2, 2018

(54) WATER-SOLUBLE UNIT DOSE ARTICLES COMPRISING WATER-SOLUBLE FIBROUS STRUCTURES AND PARTICLES

(71) Applicant: The Procter & Gamble Company, Cincinnati, OH (US)

(72) Inventors: Frank William DENOME, Cincinnati, OH (US); Mark Robert SIVIK, Mason, OH (US); Paul R. MORT, III, Cincinnati, OH (US); Mark William HAMERSKY, HAMILTON, OH (US)

(21) Appl. No.: 15/880,594

(22) Filed: Jan. 26, 2018

Related U.S. Application Data
(60) Provisional application No. 62/451,115, filed on Jan. 27, 2017.
(60) Provisional application No. 62/562,687, filed on Sep. 25, 2017.

(51) Int. Cl. C11D 17/04; C11D 1/37; C11D 3/37

(52) U.S. Cl. CPC C11D 17/044; C11D 1/146; C11D 3/3723; C11D 1/37

(57) ABSTRACT

Described herein is a household care composition, which delivers active agents onto fabric or hard surfaces, in the form of a water-soluble unit dose article comprising a water-soluble fibrous structure and one or more particles, as well as methods for making the same.

### FIELD OF THE INVENTION

Described herein is a household care composition, which delivers active agents onto fabric or hard surfaces, in the form of a water-soluble unit dose article comprising a water-soluble fibrous structure and one or more particles, as well as methods for making the same.

### BACKGROUND OF THE INVENTION

Water-soluble unit dose articles are desired by consumers as they provide a convenient, efficient, and clean way of dosing a fabric or hard surface treatment composition. Water-soluble unit dose articles provide a measured dosage of a treatment composition, thereby avoiding over or under dosing. Fibrous water-soluble unit dose articles are of increasing interest to consumers. The technology related to such articles continues to advance in terms of providing the desired active agents with the articles enabling the consumers to do the job that they wish to accomplish.

Consumers desire fibrous water-soluble unit dose articles that clean as well or better than conventional forms of fabric treatment compositions, such as liquids, powders, and unit dose articles constructed of water-soluble films. Formulators of conventional fabric detergents know that incorporating more than one kind of surfactant in a detergent may improve the cleaning performance of the detergent. For example, formulators may incorporate a combination of a more hydrophilic surfactant, such as alkyalkoxy sulfate, with a less hydrophilic surfactant, such as linear alkylbenzene sulfonate, to treat a broader variety of stains. In the context of fibrous water-soluble unit dose articles, however, formulators have discovered challenges in formulating with more hydrophilic surfactants, such as alkyalkoxy sulfate.

Water-soluble fibers (and the corresponding structures made therefrom) are produced from aqueous processing mixtures comprising active agents, such as surfactants, and filament-forming polymers. The production of water-soluble fibers is advantageous due to the very high surface area to weight ratio as fibers are being spun, which significantly reduces drying energy and time required to produce the solid form, while still providing a highly open pore structure for improved dissolution. However, the inclusion of filament-forming polymers that promote extensional rheology for making fibers can also contribute to gel-like rheology (i.e., hexagonal or lump-gel structures), which can inhibit dispersion and dissolution of more hydrophilic surfactants in the processing mixture. And, the resultant fibrous structures may have reduced dissolution in the wash (thereby leaving residue on fabrics).

Thus, there is a need to formulate fibrous water-soluble unit dose articles that include more hydrophilic surfactants, without inhibiting the processability of the fibers or the dissolution of the resultant articles in the wash. Surprisingly, it has been found that by providing a fibrous water-soluble unit dose article comprising a water-soluble fibrous structure and active agent-containing particles, where the particles contain more hydrophilic surfactants and the fibers of the fibrous structure contain less hydrophilic surfactants, a better dissolving and better cleaning fibrous water-soluble unit dose article can be made.

### SUMMARY OF THE INVENTION

The present disclosure relates to a water-soluble unit dose article comprising a water-soluble fibrous structure and a plurality of particles distributed throughout the structure, wherein the water-soluble fibrous structure comprises a plurality of fibrous elements and each fibrous element comprises at least one filament-forming material and a first surfactant, wherein said first surfactant is characterized by a Hydrophilic Index (HI) of no more than about 7.5; wherein each of said particles comprises a second surfactant, wherein said second surfactant is characterized by a HI of greater than 7.5.

The present disclosure also relates to a method for making a water-soluble unit dose article, the method comprising the steps of: spinning a filament-forming composition, which comprises at least one filament-forming material and a first surfactant characterized by a Hydrophilic Index (HI) of no more than about 7.5, from a spinning die to form a plurality of fibrous elements; associating a plurality of particles, where each of said particles comprises a second surfactant characterized by a HI of greater than 7.5, provided by a particle source with the fibrous elements to form a particle-fiber layer having a mixture of particles and fibrous elements; and collecting the mixture of particles and fibrous elements on a collection belt.

The present invention also relates to a method of laundering using an article according to the present invention, comprising the steps of, placing at least one article according to the present invention into the washing machine along with the laundry to be washed, and carrying out a washing or cleaning operation.

### BRIEF DESCRIPTION OF THE DRAWINGS

FIG. 1 is a schematic representation of a cross-sectional view of an example of a multiply fibrous structure.

FIG. 2 is a micro-CT scan image showing a cross-sectional view of an example of a water-soluble unit dose article.

FIG. 3 is a process for making plies of a material.

### DETAILED DESCRIPTION OF THE INVENTION

### Definitions

Features and benefits of the present invention will become apparent from the following description, which includes examples intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, the articles including “the,” “a” and “an” when used in a claim or in the specification, are understood to mean one or more of what is claimed or described.

As used herein, the terms “include,” “includes” and “including” are meant to be non-limiting.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, 0.25%, 0.1%, 0.05%, or 0.01%, or even 0%, by weight of the composition, of the component.

It should be understood that the term “comprise” includes also embodiments where the term “comprises” means “consists of” or “consists essentially of.” All cited patents and other documents are, in relevant part, incorporated by reference as if fully restated herein. The citation of any patent or other document is not an admission that the cited patent or other document is prior art with respect to the present invention.

In this description, all concentrations and ratios are on a weight basis of the composition unless otherwise specified.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Fibrous Water-Soluble Unit Dose Article

As used herein, the phrases “water-soluble unit dose article,” “water-soluble fibrous structure”, and “water-soluble fibrous element” mean that the unit dose article, fibrous structure, and fibrous element are miscible in water. In other words, the unit dose article, fibrous structure, or fibrous element is capable of forming a homogeneous solution with water at ambient conditions. “Ambient conditions” as used herein means 23° C.±1.0° C. and a relative humidity of 50%±2%. The water-soluble unit dose article may contain insoluble materials, which are dispersible in aqueous wash conditions to a suspension mean particle size that is less than about 20 microns, or less than about 50 microns.

These fibrous water-soluble unit dose articles can be dissolved under various wash conditions, e.g., low temperature, low water and/or short wash cycles or cycles where consumers have been overloading the machine, especially with items having high water absorption capacities, while providing sufficient delivery of active agents for the intended effect on the target consumer substrates (with similar performance as today's liquid products). Furthermore, the water-soluble unit dose articles described herein can be produced in an economical manner by spinning fibers comprising active agents. The water-soluble unit dose articles described herein also have improved cleaning performance.

The surface of the fibrous water-soluble unit dose article may comprise a printed area. The printed area may cover between about 10% and about 100% of the surface of the article. The area of print may comprise inks, pigments, dyes, blueing agents or mixtures thereof. The area of print may be opaque, translucent or transparent. The area of print may comprise a single color or multiple colors. The printed area maybe on more than one side of the article and contain instructional text and/or graphics. The surface of the water-soluble unit dose article may comprise an aversive agent, for example a bittering agent. Suitable bittering agents include, but are not limited to, naringin, sucrose octacetate, quinine hydrochloride, denatonium benzoate, or mixtures thereof. Any suitable level of aversive agent may be used. Suitable levels include, but are not limited to, 1 to 5000 ppm, or even 100 to 2500 ppm, or even 250 to 2000 ppm.

The water-soluble unit dose articles disclosed herein comprise a water-soluble fibrous structure and one or more particles. The water-soluble fibrous structure may comprise a plurality of fibrous elements, for example a plurality of filaments. The one or more particles, for example one or more active agent-containing particles, may be distributed throughout the structure. The water-soluble unit dose article may comprise a plurality of two or more and/or three or more fibrous elements that are inter-entangled or otherwise associated with one another to form a fibrous structure and one or more particles, which may be distributed throughout the fibrous structure.

Surprisingly, it has been found that by segregating the relatively more hydrophilic surfactants present in each water-soluble article to the particles, rather than the fibers of the fibrous structure, a better dissolving and better cleaning water-soluble unit dose articles may be made. Thus, the fibers of the structure contain a first surfactant that is relatively less hydrophilic, while the particles contain a second surfactant that is relatively more hydrophilic. More specifically, the water-soluble unit dose article disclosed herein may comprise a water-soluble fibrous structure and a plurality of particles distributed throughout the structure, wherein the water-soluble fibrous structure comprises a plurality of fibrous elements and each fibrous element comprises at least one filament-forming material and a first surfactant, wherein said first surfactant is characterized by a Hydrophilic Index (HI) of no more than about 7.5; wherein each of said particles comprises a second surfactant, wherein said second surfactant is characterized by a HI of greater than 7.5.

The first surfactant can be selected, for example, from the group consisting of unalkoxylated C6-C20 linear or branched alkyl sulfates (AS), C6-C20 linear alkylbenzene sulfonates (LAS), and combinations thereof. The second surfactant can be selected, for example, from the group consisting of C6-C20 linear or branched alkylalkoxylated sulfates (AAS) having a weight average degree of alkoxylation ranging from about 0.1 to about 10, C6-C20 alkylalkoxylated alcohols (AA) having a weight average degree of alkoxylation ranging from about 5 to about 15, and combinations thereof.

As used herein, “Hydrophilic Index” or “HI” of a surfactant is calculated by the following equation:

$$HI = \frac{{M}_{h}}{{M}_{T}} \times 20$$

wherein Mₕ is the molecular weight of all hydrophilic groups in the surfactant, wherein M_{T} is the total molecular weight of the surfactant. Both Mₕ and M_{T} refer to weight average molecular weights. For example, linear alkylbenzene sulfonate with an average alkyl chain length of about 11.8 has a HI value of about 4.97. For another example, C12-C14 alkyl sulfate has a HI value of about 6.98. For yet another example, C12-C14 alkylethoxylated sulfate with an average ethoxylation degree of about 1 has a HI value of about 8.78, and C12-C14 alkylethoxylated sulfate with an average ethoxylation degree of about 3 has a HI value of about 11.57. For still another example, C14-C15 alkylethoxylated alcohol with an average ethoxylation degree of about 7 has a HI value of about 12.73, and C12-C14 alkylethoxylated alcohol with an average ethoxylation degree of about 9 has a HI value of about 14.72.

The first surfactant and/or second surfactant may be the main surfactants in each of the fibrous elements and/or particles, respectively. The first surfactant may be a C6-C20 linear alkylbenzene sulfonates (LAS). The second surfactant may be a C₆-C₂₀ linear or branched AAS surfactant having a weight average degree of alkoxylation ranging from about 0.1 to about 10, or a C₁₀-C₁₆ linear or branched alkylethoxylated sulfate (AES) having a weight average degree of alkoxylation ranging from about 1 to about 5. As used herein, the term “main surfactant” refers to a surfactant which is present in an article at an amount of 50% or more, by total weight of all surfactants in such article.

The fibrous water-soluble unit dose articles may exhibit a thickness of greater than 0.01 mm and/or greater than 0.05 mm and/or greater than 0.1 mm and/or to about 100 mm and/or to about 50 mm and/or to about 20 mm and/or to about 10 mm and/or to about 5 mm and/or to about 2 mm and/or to about 0.5 mm and/or to about 0.3 mm as measured by the Thickness Test Method described herein.

The fibrous water-soluble unit dose articles may have basis weights of from about 500 grams/m² to about 5,000 grams/m², or from about 1,000 grams/m² to about 4,000 grams/m², or from about 1,500 grams/m² to about 3,500 grams/m², or from about 2,000 grams/m² to about 3,000 grams/m², as measured according to the Basis Weight Test Method described herein.

The fibrous water-soluble unit dose article may comprise a water-soluble fibrous structure and a plurality of particles distributed throughout the structure, where the water-soluble fibrous structure comprises a plurality of identical or substantially identical, from a compositional perspective, fibrous elements. The water-soluble fibrous structure may comprise two or more different fibrous elements. Non-limiting examples of differences in the fibrous elements may be physical differences, such as differences in diameter, length, texture, shape, rigidness, elasticity, and the like; chemical differences, such as crosslinking level, solubility, melting point, Tg, active agent, filament-forming material, color, level of active agent, basis weight, level of filament-forming material, presence of any coating on fibrous element, biodegradable or not, hydrophobic or not, contact angle, and the like; differences in whether the fibrous element loses its physical structure when the fibrous element is exposed to conditions of intended use; differences in whether the fibrous element's morphology changes when the fibrous element is exposed to conditions of intended use; and differences in rate at which the fibrous element releases one or more of its active agents when the fibrous element is exposed to conditions of intended use. Two or more fibrous elements within the fibrous structure may comprise different active agents. This may be the case where the different active agents may be incompatible with one another, for example an anionic surfactant and a cationic polymer. When using different fibrous elements, the resulting structure may exhibit different wetting, imbibitions, and solubility characteristics.

The fibrous water-soluble unit dose article may exhibit different regions, such as different regions of basis weight, density, caliper, and/or wetting characteristics. The fibrous water-soluble unit dose article may be compressed at the point of edge sealing. The fibrous water-soluble unit dose article may comprise texture on one or more of its surfaces. A surface of the fibrous water-soluble unit dose article may comprise a pattern, such as a non-random, repeating pattern. The fibrous water-soluble unit dose article may comprise apertures. The fibrous water-soluble unit dose article may comprise a fibrous structure having discrete regions of fibrous elements that differ from other regions of fibrous elements in the structure. The fibrous water-soluble unit dose article may be used as is or it may be coated with one or more active agents.

The fibrous water-soluble unit dose article may comprise one or more plies. The fibrous water-soluble unit dose article may comprise at least two and/or at least three and/or at least four and/or at least five plies. The fibrous plies can be fibrous structures. Each ply may comprise one or more layers, for example one or more fibrous element layers, one or more particle layers, and/or one or more fibrous element/particle mixture layers. The layer(s) may be sealed. In particular, particle layers and fibrous element/particle mixture layers may be sealed, such that the particles do not leak out. The water-soluble unit dose articles may comprise multiple plies, where each ply comprises two layers, where one layer is a fibrous element layer and one layer is a fibrous element/particle mixture layer, and where the multiple plies are sealed (e.g., at the edges) together. Sealing may inhibit the leakage of particles as well as help the unit dose article maintain its original structure. However, upon addition of the water-soluble unit dose article to water, the unit dose article dissolves and releases the particles into the wash liquor.

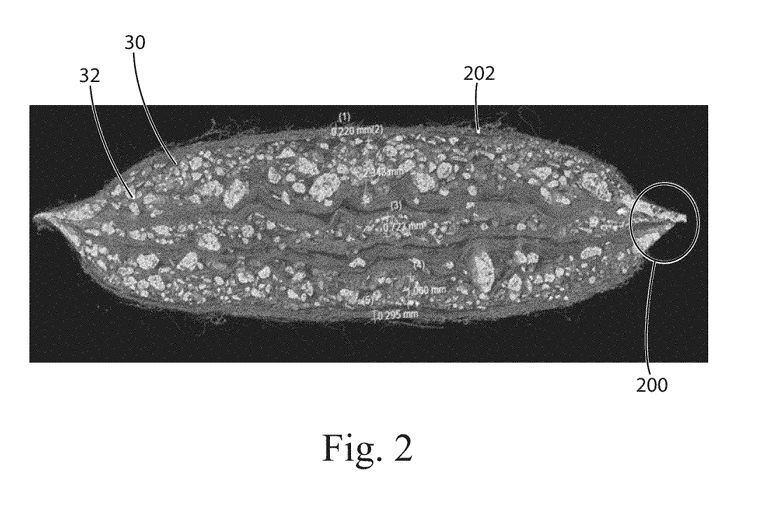

FIG. 2 is a micro-CT scan image showing a cross-sectional view of an example of a water-soluble unit dose article comprising three plies, where each ply is formed of two layers, a fibrous element layer and a fibrous element/particle mixture layer. Each of the three plies comprises a plurality of fibrous elements 30, in this case filaments, and a plurality of particles 32. The multiply, multilayer article is sealed at the edges 200, so that the particles do not leak out. The outer surfaces of the article 202 are fibrous element layers.

The fibrous elements and/or particles may be arranged within the water-soluble unit dose article, in a single ply or in multiple plies, to provide the article with two or more regions that comprise different active agents. For example, one region of the article may comprise bleaching agents and/or surfactants and another region of the article may comprise softening agents.

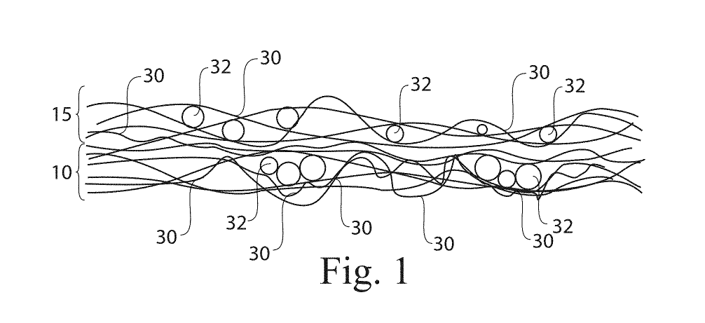

The fibrous water-soluble unit dose article can be viewed hierarchically starting from the form in which the consumer interacts with the water-soluble article and working backward to the raw materials from which the water-soluble article is made, e.g., plies, fibrous structures, and particles. The fibrous plies can be fibrous structures. For example, FIG. 1 shows a first ply 10 and a second ply 15 associated with the first ply 10, wherein the first ply 10 and the second ply 15 each comprises a plurality of fibrous elements 30, in this case filaments, and a plurality of particles 32. In the second ply 15, the particles 32 are dispersed randomly, in the x, y, and z axes, and in the first ply, the particles 32 are in pockets.

### Fibrous Structure

Fibrous structures comprise one or more fibrous elements. The fibrous elements can be associated with one another to form a structure. Fibrous structures can include particles within and or on the structure. Fibrous structures can be homogeneous, layered, unitary, zoned, or as otherwise desired, with different active agents defining the various aforesaid portions.

A fibrous structure can comprise one or more layers, the layers together forming a ply.

### Fibrous Elements

The fibrous elements may be water-soluble. The fibrous elements may comprise one or more filament-forming materials and/or one or more active agents, such as a surfactant. The one or more active agents may be releasable from the fibrous element, such as when the fibrous element and/or fibrous structure comprising the fibrous element is exposed to conditions of intended use.

The fibrous elements of the present invention may be spun from a filament-forming composition, also referred to as fibrous element-forming compositions, via suitable spinning process operations, such as meltblowing, spunbonding, electro-spinning, and/or rotary spinning.

“Filament-forming composition” and/or “fibrous element-forming composition” as used herein means a composition that is suitable for making a fibrous element of the present invention such as by meltblowing and/or spunbonding. The filament-forming composition comprises one or more filament-forming materials that exhibit properties that make them suitable for spinning into a fibrous element. The filament-forming material may comprise a polymer. In addition to one or more filament-forming materials, the filament-forming composition may comprise one or more active agents, for example, a surfactant. In addition, the filament-forming composition may comprise one or more polar solvents, such as water, into which one or more, for example all, of the filament-forming materials and/or one or more, for example all, of the active agents are dissolved and/or dispersed prior to spinning a fibrous element, such as a filament from the filament-forming composition.

The filament-forming composition may comprise two or more different filament-forming materials. Thus, the fibrous elements may be monocomponent (one type of filament-forming material) and/or multicomponent, such as bicomponent. The two or more different filament-forming materials may be randomly combined to form a fibrous element. The two or more different filament-forming materials may be orderly combined to form a fibrous element, such as a core and sheath bicomponent fibrous element, which is not considered a random mixture of different filament-forming materials for purposes of the present disclosure. Bicomponent fibrous elements may be in any form, such as side-by-side, core and sheath, islands-in-the-sea and the like.

The fibrous elements may each contain at least one filament-forming material and a first surfactant (as an active agent). The first surfactant may have a relatively low hydrophilicity (in comparison with the second surfactant contained in the particles) and may be characterized by a Hydrophilic Index (HI) of no more than about 7.5. Such a first surfactant is less likely to form a viscous, gel-like hexagonal phase when being diluted, as compared to the second surfactant. By using such a first surfactant in forming the filaments (rather than the particles), gel-formation during wash may be effectively reduced, which in turn may result in faster dissolution and low or no residues in the wash.

The first surfactant as mentioned hereinabove may be the main surfactant in each of the fibrous elements, i.e., it is present at an amount of about 50% or more, by total weight of all surfactants in the fibrous element. The first surfactant may be characterized by a HI of no more than about 7.5, or from about 4 to about 7.5, or from about 4.5 to about 7. The first surfactant can be selected, for example, from the group consisting of unalkoxylated C6-C20 linear or branched alkyl sulfates (AS), C6-C20 linear alkylbenzene sulfonates (LAS), and combinations thereof. The first surfactant may be a C6-C20 linear alkylbenzene sulfonates (LAS). LAS surfactants are well known in the art and can be readily obtained by sulfonating commercially available linear alkylbenzenes. Exemplary C₆-C₂₀ linear alkylbenzene sulfonates that can be used include alkali metal, alkaline earth metal or ammonium salts of C₆-C₂₀ linear alkylbenzene sulfonic acids, such as the sodium, potassium, magnesium and/or ammonium salts of C₁₁-C₁₈ or C₁₁-C₁₄ linear alkylbenzene sulfonic acids. The sodium or potassium salts of C₁₂ linear alkylbenzene sulfonic acids, for example, the sodium salt of C₁₂ linear alkylbenzene sulfonic acid, i.e., sodium dodecylbenzene sulfonate, may be used as the first surfactant.

The fibrous element may comprise at least about 5%, and/or at least about 10%, and/or at least about 15%, and/or at least about 20%, and/or less than about 80%, and/or less than about 75%, and/or less than about 65%, and/or less than about 60%, and/or less than about 55%, and/or less than about 50%, and/or less than about 45%, and/or less than about 40%, and/or less than about 35%, and/or less than about 30%, and/or less than about 25% by weight on a dry fibrous element basis and/or dry fibrous structure basis of the filament-forming material and greater than about 20%, and/or at least about 35%, and/or at least about 40%, and/or at least about 45%, and/or at least about 50%, and/or at least about 55%, and/or at least about 60%, and/or at least about 65%, and/or at least about 70%, and/or less than about 95%, and/or less than about 90%, and/or less than about 85%, and/or less than about 80%, and/or less than about 75% by weight on a dry fibrous element basis and/or dry fibrous structure basis of the first surfactant. The fibrous element may comprise greater than about 80% by weight on a dry fibrous element basis and/or dry fibrous structure basis of the first surfactant.

Each fibrous element may be characterized by a sufficiently high total surfactant content, e.g., at least about 30%, or at least about 40%, or at least about 50%, or at least about 60%, or at least about 70%, by weight on a dry fibrous element basis and/or dry fibrous structure basis of the first surfactant.

The total level of filament-forming materials present in the fibrous element may be from about 5% to less than about 80% by weight on a dry fibrous element basis and/or dry fibrous structure basis and the total level of first surfactant present in the fibrous element may be greater than about 20% to about 95% by weight on a dry fibrous element basis and/or dry fibrous structure basis.

The fibrous element may comprise a small amount of surfactant(s) with a relatively high hydrophilicity (in comparison with the first surfactant mentioned hereinabove) characterized by a Hydrophilic Index (HI) of more than 7.5, i.e., the second surfactant(s) as described hereinafter.

The amount of such second surfactant in each of the fibrous elements is sufficiently small so as not to affect the processing stability and film dissolution thereof, e.g., from about 0% to about 15%, or from about 0% to about 10%, or from about 0% to about 5%, or from about 0% to about 1% by weight on a dry fibrous element basis and/or dry fibrous structure basis. The fibrous element may be substantially free of alkylalkoxylated sulfates, which are preferred choices for the second surfactant (in particle). Alkylakoxylated sulfates, when dissolved in water, may undergo a highly viscous hexagonal phase at certain concentration ranges, e.g., 30-60% by weight, resulting in a gel-like substance. Therefore, if incorporated into the fibrous elements in a significant amount, alkylalkoxylated sulfates may significantly slow down the dissolution of the water-soluble unit dose articles in water, and worse yet, result in undissolved solids afterwards. Correspondingly, most of such surfactants are formulated into the particles.

One or more of the fibrous elements may comprise at least one additional surfactant selected from the group consisting of other anionic surfactants (i.e., other than AS and LAS), nonionic surfactants, zwitterionic surfactants, amphoteric surfactants, cationic surfactants, and combinations thereof.

Other suitable anionic surfactants include C₆-C₂₀ linear or branched alkyl sulfonates, C₆-C₂₀ linear or branched alkyl carboxylates, C₆-C20 linear or branched alkyl phosphates, C₆-C₂₀ linear or branched alkyl phosphonates, C₆-C₂₀ alkyl N-methyl glucose amides, C₆-C₂₀ methyl ester sulfonates (MES), and combinations thereof.

Suitable nonionic surfactants include alkoxylated fatty alcohols. The nonionic surfactant may be selected from ethoxylated alcohols and ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15. Non-limiting examples of nonionic surfactants useful herein include: C₈-C₁₈ alkylethoxylates, such as, NEODOL® nonionic surfactants from Shell; C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA; C₁₄-C₂₂ mid-chain branched alkylalkoxylates, BAEₓ, wherein x is from 1 to 30; alkylpolysaccharides; specifically alkylpolyglycosides; polyhydroxy fatty acid amides; and ether capped poly(oxyalkylated) alcohol surfactants. Suitable nonionic detersive surfactants also include alkyl polyglucoside and alkylalkoxylated alcohol. Suitable nonionic surfactants also include those sold under the tradename Lutensol® from BASF.

Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; cationic ester surfactants; and amino surfactants, e.g., amido propyldimethyl amine (APA). Suitable cationic detersive surfactants also include alkyl pyridinium compounds, alkyl quaternary ammonium compounds, alkyl quaternary phosphonium compounds, alkyl ternary sulphonium compounds, and mixtures thereof.

Suitable cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, suitable anions include: halides, for example chloride; sulphate; and sulphonate. Suitable cationic detersive surfactants are mono-C₆₋₁₈ alkyl mono-hydroxyethyl di-methyl quaternary ammonium chlorides. Highly suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Suitable examples of zwitterionic surfactants include: derivatives of secondary and tertiary amines, including derivatives of heterocyclic secondary and tertiary amines; derivatives of quaternary ammonium, quaternary phosphonium or tertiary sulfonium compounds; betaines, including alkyl dimethyl betaine, cocodimethyl amidopropyl betaine, and sulfo and hydroxy betaines; C₈ to C₁₈ (e.g., from C₁₂ to C₁₈) amine oxides; N-alkyl-N,N-dimethylammino-1-propane sulfonate, where the alkyl group can be C₈ to C₁₈.

Suitable amphoteric surfactants include aliphatic derivatives of secondary or tertiary amines, or aliphatic derivatives of heterocyclic secondary and tertiary amines in which the aliphatic radical may be straight or branched-chain and where one of the aliphatic substituents contains at least about 8 carbon atoms, or from about 8 to about 18 carbon atoms, and at least one of the aliphatic substituents contains an anionic water-solubilizing group, e.g. carboxy, sulfonate, sulfate. Suitable amphoteric surfactants also include sarcosinates, glycinates, taurinates, and mixtures thereof.

The fibrous elements may comprise a surfactant system containing only anionic surfactants, e.g., either a single anionic surfactant or a combination of two or more different anionic surfactants. Alternatively, the fibrous elements may include a composite surfactant system, e.g., containing a combination of one or more anionic surfactants with one or more nonionic surfactants, or a combination of one or more anionic surfactants with one or more zwitterionic surfactants, or a combination of one or more anionic surfactants with one or more amphoteric surfactants, or a combination of one or more anionic surfactants with one or more cationic surfactants, or a combination of all the above-mentioned types of surfactants (i.e., anionic, nonionic, amphoteric and cationic).

In general, fibrous elements are elongated particulates having a length greatly exceeding average diameter, e.g., a length to average diameter ratio of at least about 10. A fibrous element may be a filament or a fiber. Filaments are relatively longer than fibers. A filament may have a length of greater than or equal to about 5.08 cm (2 in.), and/or greater than or equal to about 7.62 cm (3 in.), and/or greater than or equal to about 10.16 cm (4 in.), and/or greater than or equal to about 15.24 cm (6 in.). A fiber may have a length of less than about 5.08 cm (2 in.), and/or less than about 3.81 cm (1.5 in.), and/or less than about 2.54 cm (1 in.).

The one or more filament-forming materials and active agents may be present in the fibrous element at a weight ratio of total level of filament-forming materials to active agents of about 2.0 or less, and/or about 1.85 or less, and/or less than about 1.7, and/or less than about 1.6, and/or less than about 1.5, and/or less than about 1.3, and/or less than about 1.2, and/or less than about 1, and/or less than about 0.7, and/or less than about 0.5, and/or less than about 0.4, and/or less than about 0.3, and/or greater than about 0.1, and/or greater than about 0.15, and/or greater than about 0.2. The one or more filament-forming materials and active agents may be present in the fibrous element at a weight ratio of total level of filament-forming materials to active agents of about 0.2 to about 0.7.

The fibrous element may comprise from about 10% to less than about 80% by weight on a dry fibrous element basis and/or dry fibrous structure basis of a filament-forming material, such as polyvinyl alcohol polymer, starch polymer, and/or carboxymethylcellulose polymer, and greater than about 20% to about 90% by weight on a dry fibrous element basis and/or dry fibrous structure basis of an active agent. The fibrous element may further comprise a plasticizer, such as glycerin, and/or pH adjusting agents, such as citric acid. The fibrous element may have a weight ratio of filament-forming material to active agent of about 2.0 or less. The filament-forming material may be selected from the group consisting of polyvinyl alcohol, starch, carboxymethylcellulose, polyethylene oxide, and other suitable polymers, especially hydroxyl-containing polymers and their derivatives. The filament-forming material may range in weight average molecular weight from about 100,000 g/mol to about 3,000,000 g/mol. It is believed that in this range, the filament-forming material may provide extensional rheology, without being so elastic that fiber attenuation is inhibited in the fiber-making process.

The one or more active agents may be releasable and/or released when the fibrous element and/or fibrous structure comprising the fibrous element is exposed to conditions of intended use. The one or more active agents in the fibrous element may be selected from the group consisting of surfactants, organic polymeric compounds, and mixtures thereof. The one or more active agents in the fibrous element may be selected from the group consisting of anionic surfactants, alkoxylated amines, and mixtures thereof. The one or more active agents in the fibrous element may be selected from the group consisting of alkylalkoxy sulfates (e.g., alkylethoxy sulfate or AES), alkoxylated polyamines, an ethylene oxide-propylene oxide-ethylene oxide (EOx₁POyEOx₂) triblock copolymer wherein each of x₁ and x₂ is in the range of about 2 to about 140 and y is in the range of from about 15 to about 70, and mixtures thereof. Suitable active agents are described in greater detail below.

The fibrous elements may exhibit a diameter of less than about 300 μm, and/or less than about 75 μm, and/or less than about 50 μm, and/or less than about 25 μm, and/or less than about 10 μm, and/or less than about 5 μm, and/or less than about 1 μm as measured according to the Diameter Test Method described herein. The fibrous elements may exhibit a diameter of greater than about 1 μm as measured according to the Diameter Test Method described herein. The diameter of a fibrous element may be used to control the rate of release of one or more active agents present in the fibrous element and/or the rate of loss and/or altering of the fibrous element's physical structure.

The fibrous element may comprise two or more different active agents, which are compatible or incompatible with one another. The fibrous element may comprise an active agent within the fibrous element and an active agent on an external surface of the fibrous element, such as an active agent coating on the fibrous element. The active agent on the external surface of the fibrous element may be the same or different from the active agent present in the fibrous element. If different, the active agents may be compatible or incompatible with one another. The one or more active agents may be uniformly distributed or substantially uniformly distributed throughout the fibrous element. The one or more active agents may be distributed as discrete regions within the fibrous element.

### Particles

The water-soluble unit dose article disclosed herein may comprise one or more particles within or on the fibrous structure. The particles may be water-soluble. The particles may contain soluble and/or insoluble material, where the insoluble material is dispersible in aqueous wash conditions to a suspension mean particle size that is less than about 20 microns. The particles may be water-soluble, e.g., substantially free of insoluble material.

The particle may be discrete. As used herein, the term “discrete” refers to particles that are structurally distinctive from each other either under naked human eyes or under electronic imaging devices, such as scanning electron microscope (SEM) and transmission electron microscope (TEM). The particles may be discrete from each other under naked human eyes.

As used herein, the term “particle” refers to a solid matter of minute quantity. The particle may be a powder, granule, agglomerate, encapsulate, microcapsule, and/or prill. The particle may be made using a number of well known methods in the art, such as spray-drying, agglomeration, extrusion, prilling, encapsulation, pastillation and combinations thereof. The shape of the particle can be in the form of spheres, rods, plates, tubes, squares, rectangles, discs, stars, or flakes of regular or irregular shapes. The particles disclosed herein are generally non-fibrous.

Each of the particles may contain a second surfactant having a relatively high hydrophilicity (in comparison with the first surfactant contained by the fibrous elements described hereinabove) and is characterized by a Hydrophilic Index (HI) of greater than 7.5. Due to its high HI value, the second surfactant is very effective in cleaning fabrics and removing stains, so it is desirable to include it into the water-soluble unit dose articles disclosed herein. However, such second surfactant of higher hydrophilicity may form a viscous, gel-like hexagonal phase while being dissolved in water. It is therefore difficult to formulate the second surfactant into the above-mentioned fibrous elements, because the viscous hexagonal phase formed by the second surfactant may adversely affect processing of the fibrous elements and formation of the fibrous structure. By formulating the second surfactant into particles that are distributed throughout the fibrous structure, such processing challenges can be readily avoided. Further, because the viscous hexagonal phase formed by the second surfactant may slow down dissolution of the water-soluble unit dose articles in water during use, it is also helpful to formulate the second surfactant into particles that can be easily dispersed in water, which improves overall dissolution of the water-soluble unit dose articles during wash.

The particles may have a relatively low water/moisture content (e.g., no more than about 10 wt % of total water/moisture, or no more than about 8 wt % of total water/moisture, or no more than about 5 wt % of total moisture), especially a relatively low free/unbound water content (e.g., no more than about 3 wt % of free or unbound water, or no more than about 1 wt % of free or unbound water), so that water from the particles will not compromise the structural integrity of the fibrous structure. Further, a controlled moisture content in the particles reduces the risk of gelling in the particles themselves. The water/moisture content present in a particle is measured using the following Water Content Test Method.

The bulk density of the particles may range from about 500 g/L to about 1000 g/L, or from about 600 g/L to about 900 g/L, or from about 700 g/L to about 800 g/L.

Like the fibrous structures and fibrous elements described hereinabove, the particles of are also characterized by a sufficiently high surfactant content, e.g., at least about 30%, or at least about 50%, or at least about 60%, and or at least about 70%, by total weight of each particle.

Each of the particles may contain a second surfactant, where such second surfactant is characterized by a HI of greater than about 7.5. The second surfactant can be selected, for example, from the group consisting of C6-C20 linear or branched alkylalkoxylated sulfates (AAS) having a weight average degree of alkoxylation ranging from about 0.1 to about 10, C6-C20 alkylalkoxylated alcohols (AA) having a weight average degree of alkoxylation ranging from about 5 to about 15, and combinations thereof. The second surfactant may be a C₆-C₂₀ linear or branched AAS surfactant having a weight average degree of alkoxylation ranging from about 0.1 to about 10, or a C₁₀-C₁₆ linear or branched alkylethoxylated sulfate (AES) having a weight average degree of alkoxylation ranging from about 1 to about 5. Such AAS (e.g., AES) surfactant can be used either alone or in combination with other surfactants. The AAS (e.g., AES) surfactant may be used as a main surfactant in each particle, i.e., it is present at an amount that is 50% or more by total weight of all surfactants in the particle, while one or more other surfactants (anionic, nonionic, amphoteric, and/or cationic) may be present as co-surfactants for such AAS (e.g., AES).

The second surfactant in the particles may be a nonionic surfactant. Suitable nonionic surfactants include alkylalkoxylated alcohols, such as alkylethoxylated alcohols and alkylethoxylated phenols of the formula R(OC₂H₄)ₙOH, where R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15. The nonionic surfactant may be selected from ethoxylated alcohols having an average of about 12-14 carbon atoms in the alcohol and an average degree of ethoxylation of about 9 moles of ethylene oxide per mole of alcohol. Other non-limiting examples of nonionic surfactants useful herein include: C₈-C₁₈ alkylethoxylates, such as, NEODOL® nonionic surfactants from Shell; C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols; C₁₄-C₂₂ mid-chain branched alkylalkoxylates, BAEₓ, wherein x is from 1 to 30; alkylpolysaccharides, and specifically alkylpolyglycosides; polyhydroxy fatty acid amides; and ether capped poly(oxyalkylated) alcohol surfactants. Suitable nonionic surfactants also include those sold under the tradename Lutensol® from BASF.

The nonionic surfactant for use as the second surfactant may be C₆-C₂₀ alkylalkoxylated alcohols (AA) having a weight average degree of alkoxylation ranging from 5 to 15, which may be present in the particles either alone or in combination with the AAS or AES surfactant described hereinabove. AA can either be present as a main surfactant or as a co-surfactant for AAS or AES in the particles. An AAS (e.g., AES) surfactant may be present as a main surfactant in the particles, while an AA surfactant is present as a co-surfactant for such AAS or AES surfactant, for example, in a weight ratio ranging from about 1:15 to about 1:2, or from about 1:10 to about 1:3, and or from about 1:8 to about 1:4.

The second surfactant may be present in each of the particles in an amount ranging from about 20% to about 90%, or from about 30% to about 90%, or from about 40% to about 90%, or from about 50% to about 90%, by total weight of each particle.

In addition to the second surfactants of relatively high HI values (i.e., greater than 7.5) as mentioned hereinabove, the particles described herein may comprise one or more additional surfactants selected from the group consisting of other anionic surfactants (i.e., other than AAS and AES), amphoteric surfactants, cationic surfactants, and combinations thereof, as described hereinabove for the fibrous structure. Such additional surfactant(s) may be present in each of the particles in an amount ranging from about 0% to about 50%, or from about 1% to about 40%, or from about 2% to about 30%, or from about 5% to about 20%, by total weight of each particle. Such additional surfactant(s) may be characterized by HI values that are lower than that of the second surfactant (i.e., no more than 7.5). For example, such additional surfactant(s) may be an anionic surfactant selected from the group consisting of C₆-C₂₀ linear or branched LAS, C₆-C₂₀ linear or branched AS, C₆-C₂₀ linear or branched alkyl sulfonates, C₆-C₂₀ linear or branched alkyl carboxylates, C₆-C₂₀ linear or branched alkyl phosphates, C₆-C₂₀ linear or branched alkyl phosphonates, C₆-C₂₀ alkyl N-methyl glucose amides, C₆-C₂₀ methyl ester sulfonates (MES), and combinations thereof. Each of the particles may further comprise about 0% to about 50%, or from about 0% to about 30%, or from about 0% to about 20%, or from about 0% to about 15% of the first surfactant as mentioned hereinabove, by total weight of each particle.

The above-mentioned surfactant(s) may form a surfactant system, which can be present in an amount ranging from about 5% to about 90%, or from about 10% to about 90%, or from about 20% to about 90%, or from about 30% to about 90%, and or from about 50% to about 90%, by total weight of the particles. The second surfactant may be present in the particles as the main surfactant, i.e., it is present at an amount of 50% or more, by total weight of the surfactant system in the particles.

The particles described herein may comprise one or more additional active agents (in addition to surfactant as described hereinabove).

When the second surfactant is AAS or AES, each of the particles may further comprise from about 0.5% to about 20%, or from about 1% to about 15%, or from about 2% to about 10% by total weight of such particle of a rheology modifier. As used herein, the term “rheology modifier” means a material that interacts with concentrated surfactants, preferably concentrated surfactants having a mesomorphic phase structure, in a way that substantially reduces the viscosity and elasticity of said concentrated surfactant. Suitable rheology modifiers include, but are not limited to, sorbitol ethoxylate, glycerol ethoxylate, sorbitan esters, tallow alkyl ethoxylated alcohol, ethylene oxide-propylene oxide-ethylene oxide (EOx₁POyEOx₂) triblock copolymers wherein each of x₁ and x₂ is in the range of about 2 to about 140 and y is in the range of from about 15 to about 70, polyethyleneimine (PEI), alkoxylated variants of PEI, and preferably ethoxylated PEI, N,N,N′,N′-tetraethoxylethylenediamine, and mixtures thereof.

The rheology modifier is preferably a “functional rheology modifier,” which means the rheology modifier has additional detergent functionality. In some cases, a dispersant polymer, described herein below, may also function as a functional rheology modifier. The rheology modifier is preferably selected from the group consisting of an alkoxylated polyalkyleneimine, an ethylene oxide-propylene oxide-ethylene oxide (EOx₁POyEOx₂) triblock copolymer wherein each of x₁ and x₂ is in the range of about 2 to about 140 and y is in the range of from about 15 to about 70, an N,N,N′,N′-tetraethoxylethylenediamine, and mixtures thereof.

The rheology modifier may comprise one of the polymers described above, for example, ethoxylated PEI, in combination with a polyalkylene glycol. When the second surfactant is AAS or AES, each of the particles may further comprise from about 0.5% to about 20%, or from about 1% to about 15%, or from about 2% to about 10% of a polyalkylene glycol, by total weight of such each discrete particle. The polyalkylene glycol may be a polyethylene glycol with a weight average molecular weight ranging from 500 to 20,000 Daltons, or from about 1000 to 15,000 Daltons, and or from 2000 to 8000 Daltons.

Alkoxylated polyalkyleneimine:

The alkoxylated polyalkyleneimine may have an empirical formula of (PEI)a(CH₂CH₂O)_{b}(CH₂CH₂CH₂O)_{c}, in which PEI is a polyethyleneimine core; a is the number average molecular weight (MWₙ) of the PEI core prior to modification, which ranges from about 100 to about 100,000 Daltons, or from about 200 to about 5000 Daltons, or from about 500 to about 1000 Daltons; b is the weight average number of ethylene oxide (CH₂CH₂O) units per nitrogen atom in the PEI core, which ranges from 0 to about 60, or from about 1 to about 50, or from about 5 to about 40, or from about 10 to about 30; and c is the weight average number of propylene oxide (CH₂CH₂CH₂O) units per nitrogen atom in the PEI core, which ranges from 0 to about 60, or from 0 to about 40, or from 0 to about 30, or from 0 to about 20.

Ethylene Oxide-Propylene Oxide-Ethylene Oxide (EOx₁POyEOx₂) Triblock Copolymer:

In the ethylene oxide-propylene oxide-ethylene oxide (EOx₁POyEOx₂) triblock copolymer, each of x₁ and x₂ is in the range of about 2 to about 140 and y is in the range of from about 15 to about 70. The ethylene oxide-propylene oxide-ethylene oxide (EOx₁POyEOx₂) triblock copolymer preferably has an average propylene oxide chain length of between 20 and 70, preferably between 30 and 60, more preferably between 45 and 55 propylene oxide units.

Preferably, the ethylene oxide-propylene oxide-ethylene oxide (EOx₁POyEOx₂) triblock copolymer has a molecular weight of between about 1000 and about 10,000 Daltons, preferably between about 1500 and about 8000 Daltons, more preferably between about 2000 and about 7000 Daltons, even more preferably between about 2500 and about 5000 Daltons, most preferably between about 3500 and about 3800 Daltons.

Preferably, each ethylene oxide block or chain independently has an average chain length of between 2 and 90, preferably 3 and 50, more preferably between 4 and 20 ethylene oxide units. Preferably, the copolymer comprises between 10% and 90%, preferably between 15% and 50%, most preferably between 15% and 25% by weight of the copolymer of the combined ethylene-oxide blocks. Most preferably the total ethylene oxide content is equally split over the two ethylene oxide blocks. Equally split herein means each ethylene oxide block comprising on average between 40% and 60% preferably between 45% and 55%, even more preferably between 48% and 52%, most preferably 50% of the total number of ethylene oxide units, the % of both ethylene oxide blocks adding up to 100%. Some ethylene oxide-propylene oxide-ethylene oxide (EOx₁POyEOx₂) triblock copolymer, where each of x₁ and x₂ is in the range of about 2 to about 140 and y is in the range of from about 15 to about 70, improve cleaning.

Preferably the copolymer has a molecular weight between about 3500 and about 3800 Daltons, a propylene oxide content between 45 and 55 propylene oxide units, and an ethylene oxide content of between 4 and 20 ethylene oxide units per ethylene oxide block.

Preferably, the ethylene oxide-propylene oxide-ethylene oxide (EOx₁POyEOx₂) triblock copolymer has a molecular weight of between 1000 and 10,000 Daltons, preferably between 1500 and 8000 Daltons, more preferably between 2000 and 7500 Daltons. Preferably, the copolymer comprises between 10% and 95%, preferably between 12% and 90%, most preferably between 15% and 85% by weight of the copolymer of the combined ethylene-oxide blocks. Some ethylene oxide-propylene oxide-ethylene oxide (EOx₁POyEOx₂) triblock copolymer, where each of x₁ and x₂ is in the range of about 2 to about 140 and y is in the range of from about 15 to about 70, improve dissolution.

Suitable ethylene oxide—propylene oxide—ethylene oxide triblock copolymers are commercially available under the Pluronic PE series from the BASF company, or under the Tergitol L series from the Dow Chemical Company. A particularly suitable material is Pluronic PE 9200.

N,N,N′,N′-tetra(2-hydroxyethyl)ethylenediamine:

N,N,N′,N′-tetra(2-hydroxyethyl)ethylenediamine is a suitable functional rheology modifier, which also has chelant activity.

The size distribution of the particles, as characterized according to the Granular Size Distribution Test Method, may have a D50 greater than about 150 μm and less than about 1600 μm, or a D50 greater than 205 μm and less than about 1000 μm, or a D50 greater than about 300 μm and a D90 less than about 850 μm, or a D50 greater than about 350 μm and less than about 700 μm.

The size distribution of the particle, as characterized according to the Granular Size Distribution Test Method, may have a D20 greater than about 150 μm and a D80 less than about 1400 μm, or a D20 greater than about 200 μm and a D80 less than about 1180 μm, or a D20 greater than about 250 μm and a D80 less than about 1000 μm.

The size distribution of the particle, as characterized according to the Granular Size Distribution Test Method, may have a D10 greater than about 150 μm and a D90 less than about 1400 μm, or a D10 greater than about 200 μm and a D90 less than about 1180 μm, or a D10 greater than about 250 μm and a D90 less than about 1000 μm.

The particles disclosed herein may optionally include one or more other active agents (e.g., adjunct detergent ingredient) for assisting or enhancing cleaning performance or to modify the aesthetics thereof. Illustrative examples of such adjunct detergent ingredients include: (1) inorganic and/or organic builders, such as carbonates (including bicarbonates and sesquicarbonates), sulphates, phosphates (exemplified by the tripolyphosphates, pyrophosphates, and glassy polymeric meta-phosphates), phosphonates, phytic acid, silicates, zeolite, citrates, polycarboxylates and salts thereof (such as mellitic acid, succinic acid, oxydisuccinic acid, polymaleic acid, benzene 1,3,5-tricarboxylic acid, carboxymethyloxysuccinic acid, and soluble salts thereof), ether hydroxypolycarboxylates, copolymers of maleic anhydride with ethylene or vinyl methyl ether, 1,3,5-trihydroxy benzene-2,4,6-trisulphonic acid, 3,3-dicarboxy-4-oxa-1,6-hexanedioates, polyacetic acids (such as ethylenediamine tetraacetic acid and nitrilotriacetic acid) and salts thereof, fatty acids (such as C12-C18 monocarboxylic acids); (2) chelating agents, such as iron and/or manganese-chelating agents selected from the group consisting of amino carboxylates, amino phosphonates, polyfunctionally-substituted aromatic chelating agents and mixtures therein; (3) clay soil removal/anti-redeposition agents, such as water-soluble ethoxylated amines (particularly ethoxylated tetraethylene-pentamine); (4) polymeric dispersing agents, such as polymeric polycarboxylates, acrylic/maleic-based copolymers and water-soluble salts thereof of, hydroxypropylacrylate, maleic/acrylic/vinyl alcohol terpolymers, polyaspartates and polyglutamates; (5) optical brighteners, which include but are not limited to derivatives of stilbene, pyrazoline, coumarin, carboxylic acid, methinecyanines, dibenzothiphene-5,5-dioxide, azoles, 5- and 6-membered-ring heterocycles, and the like; (6) suds suppressors, such as monocarboxylic fatty acids and soluble salts thereof, high molecular weight hydrocarbons (e.g., paraffins, haloparaffins, fatty acid esters, fatty acid esters of monovalent alcohols, aliphatic C₁₈-C₄₀ ketones, etc.), N-alkylated amino triazines, propylene oxide, monostearyl phosphates, silicones or derivatives thereof, secondary alcohols (e.g., 2-alkyl alkanols) and mixtures of such alcohols with silicone oils; (7) suds boosters, such as C₁₀-C₁₆ alkanolamides, C₁₀-C₁₄ monoethanol and diethanol amides, high sudsing surfactants (e g, amine oxides, betaines and sultaines), and soluble magnesium salts (e.g., MgCl₂, MgSO₄, and the like); (8) fabric softeners, such as smectite clays, amine softeners and cationic softeners; (9) dye transfer inhibiting agents, such as polyvinyl pyrrolidone polymers, polyamine N-oxide polymers, copolymers of N-vinylpyrrolidone and N-vinylimidazole, manganese phthalocyanine, peroxidases, and mixtures thereof; (10) enzymes, such as proteases, amylases, lipases, cellulases, and peroxidases, and mixtures thereof; (11) enzyme stabilizers, which include water-soluble sources of calcium and/or magnesium ions, boric acid or borates (such as boric oxide, borax and other alkali metal borates); (12) bleaching agents, such as percarbonates (e.g., sodium carbonate peroxyhydrate, sodium pyrophosphate peroxyhydrate, urea peroxyhydrate, and sodium peroxide), persulfates, perborates, magnesium monoperoxyphthalate hexahydrate, the magnesium salt of metachloro perbenzoic acid, 4-nonylamino-4-oxoperoxybutyric acid and diperoxydodecanedioic acid, 6-nonylamino-6-oxoperoxycaproic acid, and photoactivated bleaching agents (e.g., sulfonated zinc and/or aluminum phthalocyanines); (13) bleach activators, such as nonanoyloxybenzene sulfonate (NOBS), tetraacetyl ethylene diamine (TAED), amido-derived bleach activators including (6-octanamidocaproyl)oxybenzenesulfonate, (6-nonanamidocaproyl)oxybenzenesulfonate, (6-decanamidocaproyl)oxybenzenesulfonate, and mixtures thereof, benzoxazin-type activators, acyl lactam activators (especially acyl caprolactams and acyl valerolactams); and (14) any other known detergent adjunct ingredients, including but not limited to carriers, hydrotropes, processing aids, dyes or pigments (especially hueing dyes), perfumes (including both neat perfumes and perfume microcapsules), and solid fillers.

### Other Particles

In addition to the surfactant-containing particles described hereinabove, the water-soluble unit dose articles described herein may further contain other particles distributed throughout the fibrous structure. For example, such other particles may include soluble and/or insoluble material, where the insoluble material is dispersible in aqueous wash conditions to a suspension mean particle size that is less than about 20 microns.

The other particles may be a powder, granule, agglomerate, encapsulate, microcapsule, and/or prill. The other particles may be made using a number of well-known methods in the art, such as spray-drying, agglomeration, extrusion, prilling, encapsulation, pastillation and combinations thereof. The shape of the other particles can be in the form of spheres, rods, plates, tubes, squares, rectangles, discs, stars, fibers or have regular or irregular random forms.

The other particles may have a a D50 particle size of from about 150 μm to about 600 μm as measured according to the Granular Size Distribution Test Method.

The other particles may be any solid, free-flowing particles, and may include a mixture of chemically different particles, such as: surfactant particles (those substantially free of the second surfactant), including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as colored noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, these enzyme granulates may comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

### Active Agents

The water-soluble unit dose articles described herein may contain one or more active agents. The active agents may be present in the fibrous elements (as described above), in the particles (as described above), or as a premix in the article. Premixes for example, may be slurries of active agents that are combined with aqueous absorbents. The active agent may be selected from the group consisting of a surfactant, a structurant, a builder, an organic polymeric compound, an enzyme, an enzyme stabilizer, a bleach system, a brightener, a hueing agent, a chelating agent, a suds suppressor, a conditioning agent, a humectant, a perfume, a perfume microcapsule, a filler or carrier, an alkalinity system, a pH control system, a buffer, an alkanolamine, and mixtures thereof.

Surfactant

The surfactant may be selected from the group consisting of anionic surfactants, nonionic surfactants, cationic surfactants, zwitterionic surfactants, amphoteric surfactants, ampholytic surfactants, and mixtures thereof.

Anionic Surfactant

Suitable anionic surfactants may exist in an acid form, and the acid form may be neutralized to form a surfactant salt. Typical agents for neutralization include metal counterion bases, such as hydroxides, e.g., NaOH or KOH. Further suitable agents for neutralizing anionic surfactants in their acid forms include ammonia, amines, or alkanolamines Non-limiting examples of alkanolamines include monoethanolamine, diethanolamine, triethanolamine, and other linear or branched alkanolamines known in the art; suitable alkanolamines include 2-amino-1-propanol, 1-aminopropanol, monoisopropanolamine, or 1-amino-3-propanol. Amine neutralization may be done to a full or partial extent, e.g., part of the anionic surfactant mix may be neutralized with sodium or potassium and part of the anionic surfactant mix may be neutralized with amines or alkanolamines

Anionic surfactants may be supplemented with salt as a means to regulate phase behavior; suitable salts may be selected from the group consisting of sodium sulfate, magnesium sulfate, sodium carbonate, sodium citrate, sodium silicate, and mixtures thereof.

Non-limiting examples of suitable anionic surfactants include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates. Suitable anionic surfactants may be derived from renewable resources, waste, petroleum, or mixtures thereof. Suitable anionic surfactants may be linear, partially branched, branched, or mixtures thereof

Alkoxylated alkyl sulfate materials comprise ethoxylated alkyl sulfate surfactants, also known as alkyl ether sulfates or alkyl polyethoxylate sulfates. Examples of ethoxylated alkyl sulfates include water-soluble salts, particularly the alkali metal, ammonium and alkylolammonium salts, of organic sulfuric reaction products having in their molecular structure an alkyl group containing from about 8 to about 30 carbon atoms and a sulfonic acid and its salts. (Included in the term “alkyl” is the alkyl portion of acyl groups. In some examples, the alkyl group contains from about 15 carbon atoms to about 30 carbon atoms. In other examples, the alkyl ether sulfate surfactant may be a mixture of alkyl ether sulfates, said mixture having an average (arithmetic mean) carbon chain length within the range of about 12 to 30 carbon atoms, and in some examples an average carbon chain length of about 12 to 15 carbon atoms, and an average (arithmetic mean) degree of ethoxylation of from about 1 mol to 4 mols of ethylene oxide, and in some examples an average (arithmetic mean) degree of ethoxylation of 1.8 mols of ethylene oxide. In further examples, the alkyl ether sulfate surfactant may have a carbon chain length between about 10 carbon atoms to about 18 carbon atoms, and a degree of ethoxylation of from about 1 to about 6 mols of ethylene oxide. In yet further examples, the alkyl ether sulfate surfactant may contain a peaked ethoxylate distribution.

Non-alkoxylated alkyl sulfates may also be added to the disclosed detergent compositions and used as an anionic surfactant component. Examples of non-alkoxylated, e.g., non-ethoxylated, alkyl sulfate surfactants include those produced by the sulfation of higher C₈-C₂₀ fatty alcohols. In some examples, primary alkyl sulfate surfactants have the general formula: ROSO₃⁻M⁺, wherein R is typically a linear C₈-C₂₀ hydrocarbyl group, which may be straight chain or branched chain, and M is a water-solubilizing cation. In some examples, R is a C₁₀-C₁₈ alkyl, and M is an alkali metal. In other examples, R is a C₁₂/C₁₄ alkyl and M is sodium, such as those derived from natural alcohols.

Other useful anionic surfactants can include the alkali metal salts of alkyl benzene sulfonates, in which the alkyl group contains from about 9 to about 15 carbon atoms, in straight chain (linear) or branched chain configuration. In some examples, the alkyl group is linear. Such linear alkylbenzene sulfonates are known as “LAS.” In other examples, the linear alkylbenzene sulfonate may have an average number of carbon atoms in the alkyl group of from about 11 to 14. In a specific example, the linear straight chain alkyl benzene sulfonates may have an average number of carbon atoms in the alkyl group of about 11.8 carbon atoms, which may be abbreviated as C11.8 LAS.

Suitable alkyl benzene sulphonate (LAS) may be obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable. In one aspect, a magnesium salt of LAS is used.

Another example of a suitable alkyl benzene sulfonate is a modified LAS (MLAS), which is a positional isomer that contains a branch, e.g., a methyl branch, where the aromatic ring is attached to the 2 or 3 position of the alkyl chain.

The anionic surfactant may include a 2-alkyl branched primary alkyl sulfates have 100% branching at the C2 position (C1 is the carbon atom covalently attached to the alkoxylated sulfate moiety). 2-alkyl branched alkyl sulfates and 2-alkyl branched alkylalkoxy sulfates are generally derived from 2-alkyl branched alcohols (as hydrophobes). 2-alkyl branched alcohols, e.g., 2-alkyl-1-alkanols or 2-alkyl primary alcohols, which are derived from the oxo process, are commercially available from Sasol, e.g., LIAL®, ISALCHEM® (which is prepared from LIAL® alcohols by a fractionation process). C14/C15 branched primary alkyl sulfate are also commercially available, e.g., namely LIAL® 145 sulfate.

The anionic surfactant may include a mid-chain branched anionic surfactant, e.g., a mid-chain branched anionic detersive surfactant, such as, a mid-chain branched alkyl sulphate and/or a mid-chain branched alkyl benzene sulphonate.

Additional suitable anionic surfactants include methyl ester sulfonates, paraffin sulfonates, α-olefin sulfonates, and internal olefin sulfonates.

Nonionic Surfactant

Suitable nonionic surfactants include alkoxylated fatty alcohols. The nonionic surfactant may be selected from ethoxylated alcohols and ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15.

Other non-limiting examples of nonionic surfactants useful herein include: C₈-C₁₈ alkylethoxylates, such as, NEODOL® nonionic surfactants from Shell; C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA; C₁₄-C₂₂ mid-chain branched alkylalkoxylates, BAEₓ, wherein x is from 1 to 30; alkylpolysaccharides; specifically alkylpolyglycosides; polyhydroxy fatty acid amides; and ether capped poly(oxyalkylated) alcohol surfactants.

Suitable nonionic detersive surfactants also include alkyl polyglucoside and alkylalkoxylated alcohol. Suitable nonionic surfactants also include those sold under the tradename Lutensol® from BASF.

Cationic Surfactant

Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; cationic ester surfactants; and amino surfactants, e.g., amido propyldimethyl amine (APA).

Suitable cationic detersive surfactants also include alkyl pyridinium compounds, alkyl quaternary ammonium compounds, alkyl quaternary phosphonium compounds, alkyl ternary sulphonium compounds, and mixtures thereof.

Suitable cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, suitable anions include: halides, for example chloride; sulphate; and sulphonate. Suitable cationic detersive surfactants are mono-C₆₋₁₈ alkyl mono-hydroxyethyl di-methyl quaternary ammonium chlorides. Highly suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Zwitterionic Surfactant

Suitable zwitterionic surfactants include: derivatives of secondary and tertiary amines, derivatives of heterocyclic secondary and tertiary amines, or derivatives of quaternary ammonium, quaternary phosphonium or tertiary sulfonium compounds. Suitable examples of zwitterionic surfactants include betaines, including alkyl dimethyl betaine and cocodimethyl amidopropyl betaine, C₈ to C₁₈ (for example from C₁₂ to C₁₈) amine oxides, and sulfo and hydroxy betaines, such as N-alkyl-N,N-dimethylammino-1-propane sulfonate where the alkyl group can be C₈ to C₁₈.

Amphoteric Surfactant

Suitable amphoteric surfactants include aliphatic derivatives of secondary or tertiary amines, or aliphatic derivatives of heterocyclic secondary and tertiary amines in which the aliphatic radical may be straight or branched-chain and where one of the aliphatic substituents contains at least about 8 carbon atoms, or from about 8 to about 18 carbon atoms, and at least one of the aliphatic substituents contains an anionic water-solubilizing group, e.g. carboxy, sulfonate, sulfate. Suitable amphoteric surfactants also include sarcosinates, glycinates, taurinates, and mixtures thereof.

Enzymes

Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in a detergent composition, the aforementioned additional enzymes may be present at levels from about 0.00001% to about 2%, from about 0.0001% to about 1% or even from about 0.001% to about 0.5% enzyme protein by weight of the composition. The compositions disclosed herein may comprise from about 0.001% to about 1% by weight of an enzyme (as an adjunct), which may be selected from the group consisting of lipase, amylase, protease, mannanase, cellulase, pectinase, and mixtures thereof.

Builders

Suitable builders include aluminosilicates (e.g., zeolite builders, such as zeolite A, zeolite P, and zeolite MAP), silicates, phosphates, such as polyphosphates (e.g., sodium tri-polyphosphate), especially sodium salts thereof; carbonates, bicarbonates, sesquicarbonates, and carbonate minerals other than sodium carbonate or sesquicarbonate; organic mono-, di-, tri-, and tetracarboxylates, especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. Additional suitable builders may be selected from citric acid, lactic acid, fatty acid, polycarboxylate builders, for example, copolymers of acrylic acid, copolymers of acrylic acid and maleic acid, and copolymers of acrylic acid and/or maleic acid, and other suitable ethylenic monomers with various types of additional functionalities. Alternatively, the composition may be substantially free of builder.

Polymeric Dispersing Agents

Suitable polymeric dispersing agents include carboxymethylcellulose, poly(vinylpyrrolidone), poly (ethylene glycol), an ethylene oxide-propylene oxide-ethylene oxide (EOx₁POyEOx₂) triblock copolymer, where each of x₁ and x₂ is in the range of about 2 to about 140 and y is in the range of from about 15 to about 70, poly(vinyl alcohol), poly(vinylpyridine-N-oxide), poly(vinylimidazole), polycarboxylates such as polyacrylates, maleic/acrylic acid copolymers and lauryl methacrylate/acrylic acid co-polymers.

Suitable polymeric dispersing agents include amphiphilic cleaning polymers such as the compound having the following general structure: bis((C₂H₅O)(C₂H₄O)n)(CH₃)—N⁺—CₓH₂ₓ—N⁻—(CH₃)-bis((C₂H₅O)(C₂H₄O)n), wherein n=from 20 to 30, and x=from 3 to 8, or sulphated or sulphonated variants thereof.

Suitable polymeric dispersing agents include amphiphilic alkoxylated grease cleaning polymers which have balanced hydrophilic and hydrophobic properties such that they remove grease particles from fabrics and surfaces. The amphiphilic alkoxylated grease cleaning polymers may comprise a core structure and a plurality of alkoxylate groups attached to that core structure. These may comprise alkoxylated polyalkylenimines, for example, having an inner polyethylene oxide block and an outer polypropylene oxide block. Such compounds may include, but are not limited to, ethoxylated polyethyleneimine, ethoxylated hexamethylene diamine, and sulfated versions thereof. Polypropoxylated derivatives may also be included. A wide variety of amines and polyalklyeneimines can be alkoxylated to various degrees. A useful example is 600 g/mol polyethyleneimine core ethoxylated to 20 EO groups per NH and is available from BASF. The detergent compositions described herein may comprise from about 0.1% to about 10%, and in some examples, from about 0.1% to about 8%, and in other examples, from about 0.1% to about 6%, by weight of the detergent composition, of alkoxylated polyamines.

Suitable polymeric dispersing agents include carboxylate polymer. Suitable carboxylate polymers, which may optionally be sulfonated, include a maleate/acrylate random copolymer or a poly(meth)acrylate homopolymer. In one aspect, the carboxylate polymer is a poly(meth)acrylate homopolymer having a molecular weight from 4,000 Da to 9,000 Da, or from 6,000 Da to 9,000 Da.

Suitable polymeric dispersing agents include alkoxylated polycarboxylates, which may also be used to provide grease removal. Chemically, these materials comprise poly(meth)acrylates having one ethoxy side-chain per every 7-8 (meth)acrylate units. The side-chains are of the formula —(CH₂CH₂O)ₘ(CH₂)ₙCH₃ wherein m is 2-3 and n is 6-12. The side-chains are ester-linked to the polyacrylate “backbone” to provide a “comb” polymer type structure. The molecular weight can vary, but may be in the range of about 2000 to about 50,000. The detergent compositions described herein may comprise from about 0.1% to about 10%, and in some examples, from about 0.25% to about 5%, and in other examples, from about 0.3% to about 2%, by weight of the detergent composition, of alkoxylated polycarboxylates.

Suitable polymeric dispersing agents include amphiphilic graft co-polymers. A suitable amphiphilic graft co-polymer comprises (i) a polyethyelene glycol backbone; and (ii) and at least one pendant moiety selected from polyvinyl acetate, polyvinyl alcohol and mixtures thereof. A suitable amphilic graft co-polymer is Sokalan® HP22, supplied from BASF. Suitable polymers include random graft copolymers, for example, a polyvinyl acetate grafted polyethylene oxide copolymer having a polyethylene oxide backbone and multiple polyvinyl acetate side chains.

The molecular weight of the polyethylene oxide backbone is typically about 6000 and the weight ratio of the polyethylene oxide to polyvinyl acetate is about 40 to 60 and no more than 1 grafting point per 50 ethylene oxide units.

Soil Release Polymer

Suitable soil release polymers have a structure as defined by one of the following structures (I), (II) or (III):

—[(OCHR¹—CHR²)ₐ—O—OC—Ar—CO—]_{d} (I)

—[(OCHR³—CHR⁴)_{b}—O—OC-sAr—CO—]ₑ (II)

—[(OCHR⁵—CHR⁶)_{c}—OR⁷]_{f} (III)

wherein:

a, b and c are from 1 to 200;

d, e and f are from 1 to 50;

Ar is a 1,4-substituted phenylene;

sAr is 1,3-substituted phenylene substituted in position 5 with SO₃Me;

Me is Li, K, Mg/2, Ca/2, Al/3, ammonium, mono-, di-, tri-, or tetraalkylammonium wherein the alkyl groups are C₁-C₁₃ alkyl or C₂-C₁₀ hydroxyalkyl, or mixtures thereof;

R¹, R², R³, R⁴, R⁵ and R⁶ are independently selected from H or C₁-C₁₈ n- or iso-alkyl; and

R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are polyester soil release polymers such as Repel-o-tex polymers, including Repel-o-tex SF, SF-2 and SRP6 supplied by Rhodia. Other suitable soil release polymers include Texcare polymers, including Texcare SRA100, SRA300, SRN100, SRN170, SRN240, SRN300 and SRN325 supplied by Clariant. Other suitable soil release polymers are Marloquest polymers, such as Marloquest SL supplied by Sasol.

Cellulosic Polymer

Suitable cellulosic polymers including those selected from alkyl cellulose, alkylalkoxyalkyl cellulose, carboxyalkyl cellulose, alkyl carboxyalkyl cellulose. The cellulosic polymers may be selected from the group consisting of carboxymethyl cellulose, methyl cellulose, methyl hydroxyethyl cellulose, methyl carboxymethyl cellulose, and mixtures thereof. In one aspect, the carboxymethyl cellulose has a degree of carboxymethyl substitution from 0.5 to 0.9 and a molecular weight from 100,000 Da to 300,000 Da.

Amines

Non-limiting examples of amines may include, but are not limited to, polyetheramines, polyamines, oligoamines, triamines, diamines, pentamines, tetraamines, or combinations thereof. Specific examples of suitable additional amines include tetraethylenepentamine, triethylenetetraamine, diethylenetriamine, or a mixture thereof.

Bleaching Agents

Suitable bleaching agents other than bleaching catalysts include photobleaches, bleach activators, hydrogen peroxide, sources of hydrogen peroxide, pre-formed peracids and mixtures thereof. In general, when a bleaching agent is used, the detergent compositions of the present invention may comprise from about 0.1% to about 50% or even from about 0.1% to about 25% bleaching agent by weight of the detergent composition.

Bleach Catalysts

Suitable bleach catalysts include, but are not limited to: iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones and mixtures thereof.

Brighteners

Commercial fluorescent brighteners suitable for the present disclosure can be classified into subgroups, including but not limited to: derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

The fluorescent brightener may be selected from the group consisting of disodium 4,4′-bis{[4-anilino-6-morpholino-s-triazin-2-yl]-amino}-2,2′-stilbenedisulfonate (brightener 15, commercially available under the tradename Tinopal AMS-GX by BASF), disodium4,4′-bis{[4-anilino-6-(N-2-bis-hydroxyethyl)-s-triazine-2-yl]-amino}-2,2′-stilbenedisulonate (commercially available under the tradename Tinopal UNPA-GX by BASF), disodium 4,4′-bis{[4-anilino-6-(N-2-hydroxyethyl-N-methylamino)-s-triazine-2-yl]-amino}-2,2′-stilbenedisulfonate (commercially available under the tradename Tinopal SBM-GX by BASF). The fluorescent brightener may be disodium 4,4′-bis{[4-anilino-6-morpholino-s-triazin-2-yl]-amino}-2,2′-stilbenedisulfonate.

The brighteners may be added in particulate form or as a premix with a suitable solvent, for example nonionic surfactant, propanediol.

Fabric Hueing Agents

A fabric hueing agent (sometimes referred to as shading, bluing or whitening agents) typically provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Suitable fabric hueing agents include dyes, dye-clay conjugates, and organic and inorganic pigments. Suitable dyes also include small molecule dyes and polymeric dyes. Suitable small molecule dyes include small molecule dyes selected from the group consisting of dyes falling into the Colour Index (C.I.) classifications of Direct, Basic, Reactive or hydrolysed Reactive, Solvent or Disperse dyes for example that are classified as Blue, Violet, Red, Green or Black, and provide the desired shade either alone or in combination. Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Suitable polymeric dyes also include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. Suitable polymeric dyes also include polymeric dyes selected from the group consisting of Liquitint® Violet CT, carboxymethyl cellulose (CMC) covalently bound to a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

The aforementioned fabric hueing agents can be used in combination (any mixture of fabric hueing agents can be used).

Encapsulates

An encapsulate may comprise a core, a shell having an inner and outer surface, said shell encapsulating said core. The core may comprise any laundry care adjunct, though typically the core may comprise material selected from the group consisting of perfumes; brighteners; hueing dyes; insect repellants; silicones; waxes; flavors; vitamins; fabric softening agents; skin care agents in one aspect, paraffins; enzymes; anti-bacterial agents; bleaches; sensates; and mixtures thereof; and said shell may comprise a material selected from the group consisting of polyethylenes; polyamides; polyvinylalcohols, optionally containing other co-monomers; polystyrenes; polyisoprenes; polycarbonates; polyesters; polyacrylates; aminoplasts, in one aspect said aminoplast may comprise a polyureas, polyurethane, and/or polyureaurethane, in one aspect said polyurea may comprise polyoxymethyleneurea and/or melamine formaldehyde; polyolefins; polysaccharides, in one aspect said polysaccharide may comprise alginate and/or chitosan; gelatin; shellac; epoxy resins; vinyl polymers; water insoluble inorganics; silicone; and mixtures thereof.

Preferred encapsulates comprise perfume. Preferred encapsulates comprise a shell which may comprise melamine formaldehyde and/or cross linked melamine formaldehyde. Other preferred capsules comprise a polyacrylate based shell. Preferred encapsulates comprise a core material and a shell, said shell at least partially surrounding said core material, is disclosed. At least 75%, 85% or even 90% of said encapsulates may have a fracture strength of from 0.2 MPa to 10 MPa, and a benefit agent leakage of from 0% to 20%, or even less than 10% or 5% based on total initial encapsulated benefit agent. Preferred are those in which at least 75%, 85% or even 90% of said encapsulates may have (i) a particle size of from 1 microns to 80 microns, 5 microns to 60 microns, from 10 microns to 50 microns, or even from 15 microns to 40 microns, and/or (ii) at least 75%, 85% or even 90% of said encapsulates may have a particle wall thickness of from 30 nm to 250 nm, from 80 nm to 180 nm, or even from 100 nm to 160 nm. Formaldehyde scavengers may be employed with the encapsulates, for example, in a capsule slurry and/or added to a composition before, during or after the encapsulates are added to such composition.

Suitable capsules that can be made using known processes. Alternatively, suitable capsules can be purchased from Encapsys LLC of Appleton, Wis. USA. The composition may comprise a deposition aid, for example, in addition to encapsulates. Preferred deposition aids are selected from the group consisting of cationic and nonionic polymers. Suitable polymers include cationic starches, cationic hydroxyethylcellulose, polyvinylformaldehyde, locust bean gum, mannans, xyloglucans, tamarind gum, polyethyleneterephthalate and polymers containing dimethylaminoethyl methacrylate, optionally with one or more monomers selected from the group comprising acrylic acid and acrylamide.

Perfumes

Non-limiting examples of perfume and perfumery ingredients include, but are not limited to, aldehydes, ketones, esters, and the like. Other examples include various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can comprise extremely complex mixtures of such ingredients. Finished perfumes may be included at a concentration ranging from about 0.01% to about 2% by weight of the detergent composition.

Dye Transfer Inhibiting Agents

Dye transfer inhibiting agents are effective for inhibiting the transfer of dyes from one fabric to another during the cleaning process. Generally, such dye transfer inhibiting agents may include polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents may be used at a concentration of about 0.0001% to about 10%, by weight of the composition, in some examples, from about 0.01% to about 5%, by weight of the composition, and in other examples, from about 0.05% to about 2% by weight of the composition.

Chelating Agents

Suitable chelating agents include copper, iron and/or manganese chelating agents and mixtures thereof. Such chelating agents can be selected from the group consisting of phosphonates, amino carboxylates, amino phosphonates, succinates, polyfunctionally-substituted aromatic chelating agents, 2-pyridinol-N-oxide compounds, hydroxamic acids, carboxymethyl inulins and mixtures thereof. Chelating agents can be present in the acid or salt form including alkali metal, ammonium, and substituted ammonium salts thereof, and mixtures thereof. Other suitable chelating agents for use herein are the commercial DEQUEST series, and chelants from Monsanto, Akzo-Nobel, DuPont, Dow, the Trilon® series from BASF and Nalco.

Suds Suppressors

Compounds for reducing or suppressing the formation of suds can be incorporated into the water-soluble unit dose articles. Suds suppression can be of particular importance in the so-called “high concentration cleaning process” and in front-loading style washing machines. Examples of suds supressors include monocarboxylic fatty acid and soluble salts therein, high molecular weight hydrocarbons such as paraffin, fatty acid esters (e.g., fatty acid triglycerides), fatty acid esters of monovalent alcohols, aliphatic C₁₈-C₄₀ ketones (e.g., stearone), N-alkylated amino triazines, waxy hydrocarbons having a melting point below about 100° C., silicone suds suppressors, and secondary alcohols.

Additional suitable antifoams are those derived from phenylpropylmethyl substituted polysiloxanes.

The detergent composition may comprise a suds suppressor selected from organomodified silicone polymers with aryl or alkylaryl substituents combined with silicone resin and a primary filler, which is modified silica. The detergent compositions may comprise from about 0.001% to about 4.0%, by weight of the composition, of such a suds suppressor.

The detergent composition comprises a suds suppressor selected from: a) mixtures of from about 80 to about 92% ethylmethyl, methyl(2-phenylpropyl) siloxane; from about 5 to about 14% MQ resin in octyl stearate; and from about 3 to about 7% modified silica; b) mixtures of from about 78 to about 92% ethylmethyl, methyl(2-phenylpropyl) siloxane; from about 3 to about 10% MQ resin in octyl stearate; from about 4 to about 12% modified silica; or c) mixtures thereof, where the percentages are by weight of the anti-foam.

Suds Boosters

If high sudsing is desired, suds boosters such as the C₁₀-C₁₆ alkanolamides may be used. Some examples include the C₁₀-C₁₄ monoethanol and diethanol amides. If desired, water-soluble magnesium and/or calcium salts such as MgCl₂, MgSO₄, CaCl₂, CaSO₄, and the like, may be added at levels of about 0.1% to about 2% by weight of the detergent composition, to provide additional suds and to enhance grease removal performance.

Conditioning Agents

Suitable conditioning agents include high melting point fatty compounds. The high melting point fatty compound useful herein has a melting point of 25° C. or higher, and is selected from the group consisting of fatty alcohols, fatty acids, fatty alcohol derivatives, fatty acid derivatives, and mixtures thereof. Suitable conditioning agents also include nonionic polymers and conditioning oils, such as hydrocarbon oils, polyolefins, and fatty esters.

Suitable conditioning agents include those conditioning agents characterized generally as silicones (e.g., silicone oils, polyoils, cationic silicones, silicone gums, high refractive silicones, and silicone resins), organic conditioning oils (e.g., hydrocarbon oils, polyolefins, and fatty esters) or combinations thereof, or those conditioning agents which otherwise form liquid, dispersed particles in the aqueous surfactant matrix herein.

Fabric Enhancement Polymers

Suitable fabric enhancement polymers are typically cationically charged and/or have a high molecular weight. The fabric enhancement polymers may be a homopolymer or be formed from two or more types of monomers. The monomer weight of the polymer will generally be between 5,000 and 10,000,000, typically at least 10,000 and preferably in the range 100,000 to 2,000,000. Preferred fabric enhancement polymers will have cationic charge densities of at least 0.2 meq/gm, preferably at least 0.25 meq/gm, more preferably at least 0.3 meq/gm, but also preferably less than 5 meq/gm, more preferably less than 3 meq/gm, and most preferably less than 2 meq/gm at the pH of intended use of the composition, which pH will generally range from pH 3 to pH 9, preferably between pH 4 and pH 8. The fabric enhancement polymers may be of natural or synthetic origin.

Pearlescent Agent

Non-limiting examples of pearlescent agents include: mica; titanium dioxide coated mica; bismuth oxychloride; fish scales; mono and diesters of alkylene glycol. The pearlescent agent may be ethyleneglycoldistearate (EGDS).

Hygiene and Malodour

Suitable hygiene and malodor active agents include zinc ricinoleate, thymol, quaternary ammonium salts such as Bardac®, polyethylenimines (such as Lupasol® from BASF) and zinc complexes thereof, silver and silver compounds, especially those designed to slowly release Ag⁺ or nano-silver dispersions.

Buffer System

The water-soluble unit dose articles described herein may be formulated such that, during use in aqueous cleaning operations, the wash water will have a pH of between about 7.0 and about 12, and in some examples, between about 7.0 and about 11. Techniques for controlling pH at recommended usage levels include the use of buffers, alkalis, or acids, and are well known to those skilled in the art. These include, but are not limited to, the use of sodium carbonate, citric acid or sodium citrate, lactic acid or lactate, monoethanol amine or other amines, boric acid or borates, and other pH-adjusting compounds well known in the art.

The detergent compositions herein may comprise dynamic in-wash pH profiles. Such detergent compositions may use wax-covered citric acid particles in conjunction with other pH control agents such that (i) about 3 minutes after contact with water, the pH of the wash liquor is greater than 10; (ii) about 10 minutes after contact with water, the pH of the wash liquor is less than 9.5; (iii) about 20 minutes after contact with water, the pH of the wash liquor is less than 9.0; and (iv) optionally, wherein, the equilibrium pH of the wash liquor is in the range of from about 7.0 to about 8.5.

Method for Making

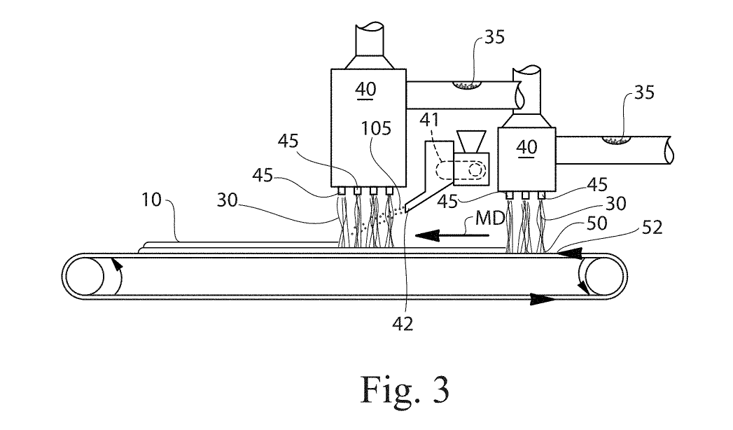

As exemplified by illustration in FIG. 3, a solution of a filament forming composition 35 is provided. The filament forming composition can comprise one or more filament forming materials and optionally one or more active agents. The filament forming composition 35 is passed through one or more die block assemblies 40 comprising a plurality of spinnerets 45 to form a plurality of fibrous elements 30 comprising the one or more filament forming materials and optionally one or more active agents. Multiple die block assemblies 40 can be employed to spin different layers of fibrous elements 30, with the fibrous elements 30 of different layers having a composition that differ from one another or are the same as one another. More than two die block assemblies in series can be provided to form three, four, or any other integer number of layers in a given ply. The fibrous elements 30 can be deposited on a belt 50 moving in a machine direction MD to form a first ply 10.

Particles can be introduced into the stream of the fibrous elements 30 between the die block assembly 40 and the belt 50. Particles can be fed from a particle receiver onto a belt feeder 41 or optionally a screw feeder. The belt feeder 41 can be set and controlled to deliver the desired mass of particles into the process. The belt feeder can feed an air knife 42 that suspends and directs the particles in an air stream into the fibrous elements 30 to form a particle-fiber layer of commingled fibrous elements 30 and particles that is subsequently deposited on the belt 50.

To form the water-soluble product, a first ply 10 can be provided. A second ply 15 can be provided separate from the first ply 10. The first ply 10 and the second ply 15 are superposed with one another. By superposed it is meant that one is positioned above or below the other with the proviso that additional plies or other materials, for example active agents, may be positioned between the superposed plies. A portion of the first ply 10 can be joined to a portion of the second ply 15 to form the water-soluble product 5. Each ply may comprise one or more layers.

### Particle-Fiber Layer

A particle-fiber layer may be arranged in several ways. Clusters of particles may be distributed in pockets distributed in the layer, where such pockets may be formed between layers of fibrous elements; the contact network and porosity within each cluster of particles is governed by physics of conventional particle packing, yet the clusters are substantially dilated in the layer. The particles may be distributed relatively homogeneously throughout the fibrous structure, substantially free of local particle clusters; packing is substantially dilated on the scale of individual particles, with fewer inter-particle contacts and greater inter-particle porosity. Without wishing to be bound by theory, it is believed that a water-soluble unit dose article comprising a layer comprising fibrous elements and particles, where sticky surfactants, such as AES, are segregated into particles having a dilated structure, provides for an improvement in dispersion and dissolution of the unit dose article, both by faster imbibition of water into the dilated structure and by a reduction in contacts among particles having sticky surfactants.

### Method of Laundering

The present invention also encompasses a method of laundering using an article according to the present invention, comprising the steps of, placing at least one article according to the present invention into the washing machine along with the laundry to be washed, and carrying out a washing or cleaning operation.

Any suitable washing machine may be used. Those skilled in the art will recognize suitable machines for the relevant wash operation. The article of the present invention may be used in combination with other compositions, such as fabric additives, fabric softeners, rinse aids and the like.

The wash temperature may be 30° C. or less. The wash process may comprise at least one wash cycle having a duration of between 5 and 20 minutes. The automatic laundry machine may comprise a rotating drum, and wherein during at least one wash cycle, the drum has a rotational speed of between 15 and 40 rpm, preferably between 20 and 35 rpm.

Specific contemplated aspects of the disclosure are herein described in the following numbered paragraphs.
1. A water-soluble unit dose article comprising a water-soluble fibrous structure and a plurality of particles distributed throughout the structure, wherein the water-soluble fibrous structure comprises a plurality of fibrous elements and each fibrous element comprises at least one filament-forming material and a first surfactant, wherein said first surfactant is characterized by a Hydrophilic Index (HI) of no more than about 7.5; wherein each of said particles comprises a second surfactant, wherein said second surfactant is characterized by a HI of greater than 7.5.
2. The water-soluble unit dose article of paragraph 1, wherein the first surfactant is selected from the group consisting of unalkoxylated C6-C20 linear or branched alkyl sulfates (AS), C6-C20 linear alkylbenzene sulfonates (LAS), and combinations thereof, preferably C6-C20 linear alkylbenzene sulfonates (LAS).
3. The water-soluble unit dose article of any of the preceding paragraphs, wherein the second surfactant is selected from the group consisting of C6-C20 linear or branched alkylalkoxylated sulfates (AAS) having a weight average degree of alkoxylation ranging from 0.1 to 10, C6-C20 alkylalkoxylated alcohols (AA) having a weight average degree of alkoxylation ranging from 5 to 15, and combinations thereof.
4. The water-soluble unit dose article of any of the preceding paragraphs, wherein the first surfactant is present as the main surfactant in each of the fibrous elements, and wherein preferably the second surfactant is present as the main surfactant in each of the particles.
5. The waxer-soluble unit dose article of any of the preceding paragraphs wherein each of the particles comprises from about 5% to about 60% by weight of the particle of the second surfactant.
6. The water-soluble unit dose article of any of the preceding paragraphs wherein each fibrous element comprises from about 10% to about 90% by weight, preferably from about 20% to about 80% by weight, more preferably from about 30% to about 70% by weight on a dry fibrous element basis of the first surfactant.
7. The water-soluble unit dose article of any of the preceding paragraphs wherein said water-soluble unit dose article further comprises at least one particle comprising an active agent selected from the group consisting of a a structurant, a builder, a polymeric dispersing agent, an enzyme, an enzyme stabilizer, a bleach system, a brightener, a hueing agent, a chelating agent, a suds suppressor, a conditioning agent, a humectant, a perfume, a perfume microcapsule, a filler or carrier, an alkalinity system, a pH control system, a buffer, an alkanolamine, a mosquito repellant, and mixtures thereof.
8. The water-soluble unit dose article of any of the preceding paragraphs wherein said water-soluble unit dose article further comprises at least one particle comprising one or more water-insoluble materials.
9. The water-dispersible unit dose article of any of the preceding paragraphs wherein said insoluble material is dispersible to a suspension mean particle size of less than about 20 microns, or less than about 50 microns.
10. The water-soluble unit dose article of any of the preceding paragraphs wherein said particles have a D50 particle size of from about 150 μm to about 1600 μm as measured according to the Granular Size Distribution Test Method.
11. The water-soluble unit dose article of any of the preceding paragraphs wherein said fibrous elements are filaments, fibers, or a mixture thereof, preferably said fibrous elements are filaments.
12. The water-soluble unit dose article of any of the preceding paragraphs wherein said filament-forming material comprises a polymer, preferably said polymer is selected from the group consisting of polyvinyl alcohols, polyalkylene glycols, starch or modified starch, cellulose or modified cellulose, polyacrylates, polymethacrylates, polyacrylamides, polyvinylpyrrolidones, and combinations thereof; and wherein more preferably said water-soluble polymer is selected from the group consisting of polyvinyl alcohols, polyalkylene glycols, and combinations thereof.
13. The water-soluble unit dose article of any of the preceding paragraphs, wherein each of said fibrous elements comprises from about 0% to about 15%, preferably from about 0% to about 10%, more preferably from about 0% to about 5%, most preferably from about 0% to about 1% of the second surfactant, by weight on a dry fibrous element basis.
14. The water-soluble unit dose article of any of the preceding paragraphs, wherein the second surfactant is a C6-C20 linear or branched AAS surfactant having a weight average degree of alkoxylation ranging from 0.1 to 10, preferably a C10-C16 linear or branched alkylethoxylated sulfate (AES) having a weight average degree of alkoxylation ranging from 1 to 5.
15. The water-soluble unit dose article of any of the preceding paragraphs, wherein each of said particles further comprises from 0.5% to 20%, preferably from 1% to 15%, more preferably from 2% to 10% by total weight of said each discrete particle of a rheology modifier selected from the group consisting of an alkoxylated polyalkyleneimine, an ethylene oxide-propylene oxide-ethylene oxide (EOx₁POyEOx₂) triblock copolymer wherein each of x₁ and x₂ is in the range of about 2 to about 140, preferably about 2 to about 100, more preferably about 2 to about 80, and y is in the range of from about 15 to about 70, N,N,N′,N′-tetra(2-hydroxyethyl)ethylenediamine, and mixtures thereof, wherein preferably said alkoxylated polyalkyleneimine has an empirical formula of (PEI)a(CH2CH2O)b(CH2CH2CH2O)c, wherein PEI is a polyethyleneimine core; wherein a is the number average molecular weight (MWn) of the PEI core prior to modification, which ranges from 100 to 100,000 Daltons, preferably from 200 to 5000 Daltons, more preferably from 500 to 1000 Daltons; wherein b is the weight average number of ethylene oxide (CH2CH2O) units per nitrogen atom in the PEI core, which ranges from 0 to 60, preferably from 1 to 50, more preferably from 5 to 40, most preferably from 10 to 30; and wherein c is the weight average number of propylene oxide (CH2CH2CH2O) units per nitrogen atom in the PEI core, which ranges from 0 to 60, preferably from 0 to 40, more preferably from 0 to 30, most preferably from 0 to 20.
16. The water-soluble unit dose article of any of the preceding paragraphs, wherein each of said particles further comprises 0.5% to 20%, preferably from 1% to 15%, more preferably from 2% to 10%, of a polyalkylene glycol, by total weight of said each discrete particle, wherein said polyalkylene glycol is preferably a polyethylene glycol with a weight average molecular weight ranging from 500 to 20,000 Daltons, preferably from about 1000 to 15,000 Daltons, and more preferably from 2000 to 8000 Daltons.
17. The water-soluble unit dose article of any of the preceding paragraphs wherein said water-soluble unit dose article exhibits a Wash Residue Test grade of less than or equal to about 1.0 as measured according to the Wash Residue Test Method.
18. The water-soluble unit dose article of any of the preceding paragraphs wherein said water-soluble unit-dose article has a Basis Weight of from about 500 grams/m2 to about 5,000 grams/m2, preferably from about 1,000 grams/m2 to about 4,000 grams/m2, more preferably from about 1,500 grams/m2 to about 3,500 grams/m2, even more preferably from about 2,000 grams/m2 to about 3,000 grams/m2, as measured according to the Basis Weight Test Method described herein.
19. The water-soluble unit dose article of any of the preceding paragraphs wherein each of said particles further comprises an ethylene oxide-propylene oxide-ethylene oxide (EOx₁POyEOx₂) triblock copolymer having an average propylene oxide chain length of between 20 and 70, preferably between 30 and 60, more preferably between 45 and 55 propylene oxide units.
20. The water-soluble unit dose article of any of the preceding paragraphs wherein each of said particles further comprises an ethylene oxide-propylene oxide-ethylene oxide (EOx₁POyEOx₂) triblock copolymer having a molecular weight of between 1000 and 15,000 Daltons, preferably between 1500 and 5000 Daltons, more preferably between 2000 and 4500 Daltons, even more preferably between 2500 and 4000 Daltons, most preferably between 3500 and 3800 Daltons, preferably each ethylene oxide block or chain of the ethylene oxide-propylene oxide-ethylene oxide (EOx₁POyEOx₂) triblock copolymer independently has an average chain length of between 2 and 90, preferably 3 and 50, more preferably between 4 and 20 ethylene oxide units, preferably the ethylene oxide-propylene oxide-ethylene oxide (EOx₁POyEOx₂) triblock copolymer comprises between 10% and 90%, preferably between 15% and 50%, most preferably between 15% and 25% by weight of the copolymer of the combined ethylene-oxide blocks.
21. The water-soluble unit dose article of any of the preceding paragraphs wherein each of said particles further comprises an ethylene oxide-propylene oxide-ethylene oxide (EOx₁POyEOx₂) triblock copolymer, wherein the total ethylene oxide content of the ethylene oxide-propylene oxide-ethylene oxide (EOx₁POyEOx₂) triblock copolymer is equally split over the two ethylene oxide blocks, preferably each ethylene oxide block comprises on average between 40% and 60%, more preferably between 45% and 55%, even more preferably between 48% and 52%, most preferably 50% of the total number of ethylene oxide units, where the % of both ethylene oxide blocks adds up to 100%.
22, The water-soluble unit dose article of any of the preceding paragraphs wherein each of said particles further comprises an ethylene oxide-propylene oxide-ethylene oxide (EOx₁POyEOx₂) triblock copolymer, wherein the ethylene oxide-propylene oxide-ethylene oxide (EOx₁POyEOx₂) triblock copolymer has a molecular weight between 3500 and 3800 Daltons, a propylene oxide content between 45 and 55 propylene oxide units, and an ethylene oxide content of between 4 and 20 ethylene oxide units per ethylene oxide block.

### Test Methods

### Water Content Test Method

The water (moisture) content present in a particle and/or substrate structure is measured using the following Water Content Test Method. A particle or portion thereof (“sample”) in the form of a pre-cut sheet is placed in a conditioned room at a temperature of 23° C.±1.0° C. and a relative humidity of 50%±2% for at least 24 hours prior to testing. Each structure sample has an area of at least 4 square inches, but small enough in size to fit appropriately on the balance weighing plate. Under the temperature and humidity conditions mentioned above, using a balance with at least four decimal places, the weight of the sample is recorded every five minutes until a change of less than 0.5% of previous weight is detected during a 10-minute period. The final weight is recorded as the “equilibrium weight”. Within 10 minutes, the samples are placed into the forced air oven on top of foil for 24 hours at 70° C.±2° C. at a relative humidity of 4% 2% for drying. After the 24 hours of drying, the sample is removed and weighed within 15 seconds. This weight is designated as the “dry weight” of the sample.

The water (moisture) content of the sample is calculated as follows:

$$\% Water in sample = 100 \% \times \frac{( Equilibrium weight of sample - Dry weight of sample )}{Dry weight of sample}$$

The % Water (moisture) in sample for 3 replicates is averaged to give the reported % Water (moisture) in sample. Report results to the nearest 0.1%.

Basis Weight Test Method

Basis weight of a fibrous structure is measured on stacks of twelve usable units using a top loading analytical balance with a resolution of ±0.001 g. The balance is protected from air drafts and other disturbances using a draft shield. A precision cutting die, measuring 3.500 in ±0.0035 in by 3.500 in ±0.0035 in is used to prepare all samples.

With a precision cutting die, cut the samples into squares. Combine the cut squares to form a stack twelve samples thick. Measure the mass of the sample stack and record the result to the nearest 0.001 g.

The Basis Weight is calculated in lbs/3000 ft² or g/m² as follows:

Basis Weight=(Mass of stack)/[(Area of 1 square in stack)×(No. of squares in stack)]

For example,

Basis Weight (lbs/3000 ft²)=[[Mass of stack (g)/453.6 (g/lbs)]/[12.25 (int)/144 (int/ft²)×12]]×3000

or,

Basis Weight (g/m²)=Mass of stack (g)/[79.032 (cm²)/10,000 (cm²/m²)×12]

Report result to the nearest 0.1 lbs/3000 ft² or 0.1 g/m². Sample dimensions can be changed or varied using a similar precision cutter as mentioned above, so as at least 100 square inches of sample area in stack.

### Thickness Test Method

Thickness of a fibrous structure is measured by cutting 5 samples of a fibrous structure sample such that each cut sample is larger in size than a load foot loading surface of a VIR Electronic Thickness Tester Model II available from Thwing-Albert Instrument Company, Philadelphia, Pa. Typically, the load foot loading surface has a circular surface area of about 3.14 in². The sample is confined between a horizontal flat surface and the load foot loading surface. The load foot loading surface applies a confining pressure to the sample of 15.5 g/cm². The thickness of each sample is the resulting gap between the flat surface and the load foot loading surface. The thickness is calculated as the average thickness of the five samples. The result is reported in millimeters (mm).

### Granular Size Distribution Test Method

The granular size distribution test is conducted to determine characteristic sizes of particles. It is conducted using ASTM D 502-89, “Standard Test Method for Particle Size of Soaps and Other Detergents”, approved May 26, 1989, with a further specification for sieve sizes and sieve time used in the analysis. Following section 7, “Procedure using machine-sieving method,” a nest of clean dry sieves containing U.S. Standard (ASTM E 11) sieves #4 (4.75 mm), #6 (3.35 mm), #8 (2.36 mm), #12 (1.7 mm), #16 (1.18 mm), #20 (850 um), #30 (600 um), #40 (425 um), #50 (300 um), #70 (212 um), #100 (150 um) is required to cover the range of particle sizes referenced herein. The prescribed Machine-Sieving Method is used with the above sieve nest. A suitable sieve-shaking machine can be obtained from W.S. Tyler Company, Ohio, U.S.A. The sieve-shaking test sample is approximately 100 grams and is shaken for 5 minutes.

The data are plotted on a semi-log plot with the micron size opening of each sieve plotted against the logarithmic abscissa and the cumulative mass percent (Q₃) plotted against the linear ordinate. An example of the above data representation is given in ISO 9276-1:1998, “Representation of results of particle size analysis—Part 1: Graphical Representation”, Figure A.4. A characteristic particle size (Dx), for the purpose of this invention, is defined as the abscissa value at the point where the cumulative mass percent is equal to x percent, and is calculated by a straight line interpolation between the data points directly above (a) and below (b) the x % value using the following equation:

Dx=10̂[Log(Da)−(Log(Da)−Log(Db))*(Qa−x%)/(Qa−Qb)]

where Log is the base-10 logarithm, Qa and Qb are the cumulative mass percentile values of the measured data immediately above and below the x^{th} percentile, respectively; and Da and Db are the micron sieve size values corresponding to these data.
Example data and calculations:

| sieve size (um) | weight on sieve (g) | cumulative mass % finer (CMPF) |
|---|---|---|
| 4750 | 0 | 100% |
| 3350 | 0 | 100% |
| 2360 | 0 | 100% |
| 1700 | 0 | 100% |
| 1180 | 0.68 | 99.3% |
| 850 | 10.40 | 89.0% |
| 600 | 28.73 | 60.3% |
| 425 | 27.97 | 32.4% |
| 300 | 17.20 | 15.2% |
| 212 | 8.42 | 6.8% |
| 150 | 4.00 | 2.8% |
| pan | 2.84 | 0.0% |

For D10 (x=10%), the micron screen size where CMPF is immediately above 10% (Da) is 300 um, the screen below (Db) is 212 um. The cumulative mass immediately above 10% (Qa) is 15.2%, below (Qb) is 6.8%.

D10=10̂[Log(300)−(Log(300)−Log(212))*(15.2%−10%)/(15.2%−6.8%)]=242 um

For D50 (x=50%), the micron screen size where CMPF is immediately above 50% (Da) is 1180 um, the screen below (Db) is 850 um. The cumulative mass immediately above 90% (Qa) is 99.3%, below (Qb) is 89.0%.

D50=10̂[Log(600)−(Log(600)−Log(425))*(60.3%−50%)/(60.3%−32.4%)]=528 um

For D90 (x=90%), the micron screen size where CMPF is immediately above 90% (Da) is 600 um, the screen below (Db) is 425 um. The cumulative mass immediately above 50% (Qa) is 60.3%, below (Qb) is 32.4%.

D90=10̂[Log(1180)−(Log(1180)−Log(850))*(99.3%−90%)/(99.3%−89.0%)]=878 um

### Diameter Test Method

The diameter of a discrete fibrous element or a fibrous element within a fibrous structure is determined by using a Scanning Electron Microscope (SEM) or an Optical Microscope and an image analysis software. A magnification of 200 to 10,000 times is chosen such that the fibrous elements are suitably enlarged for measurement. When using the SEM, the samples are sputtered with gold or a palladium compound to avoid electric charging and vibrations of the fibrous element in the electron beam. A manual procedure for determining the fibrous element diameters is used from the image (on monitor screen) taken with the SEM or the optical microscope. Using a mouse and a cursor tool, the edge of a randomly selected fibrous element is sought and then measured across its width (i.e., perpendicular to fibrous element direction at that point) to the other edge of the fibrous element. A scaled and calibrated image analysis tool provides the scaling to get actual reading in um. For fibrous elements within a fibrous structure, several fibrous element are randomly selected across the sample of the fibrous structure using the SEM or the optical microscope. At least two portions of the fibrous structure are cut and tested in this manner. Altogether at least 100 such measurements are made and then all data are recorded for statistical analysis. The recorded data are used to calculate average (mean) of the fibrous element diameters, standard deviation of the fibrous element diameters, and median of the fibrous element diameters.

Another useful statistic is the calculation of the amount of the population of fibrous elements that is below a certain upper limit. To determine this statistic, the software is programmed to count how many results of the fibrous element diameters are below an upper limit and that count (divided by total number of data and multiplied by 100%) is reported in percent as percent below the upper limit, such as percent below 1 micrometer diameter or %-submicron, for example. We denote the measured diameter (in μm) of an individual circular fibrous element as di.

In the case that the fibrous elements have non-circular cross-sections, the measurement of the fibrous element diameter is determined as and set equal to the hydraulic diameter which is four times the cross-sectional area of the fibrous element divided by the perimeter of the cross-section of the fibrous element (outer perimeter in case of hollow fibrous elements). The number-average diameter, alternatively average diameter is calculated as:

$${d}_{num} = \frac{{\sum }_{i = 1}^{n} {d}_{i}}{n}$$

### MicroCT Methods for QB02625

Samples to be tested are imaged using a microCT X-ray scanning instrument capable of acquiring a dataset at an isotropic spatial resolution of 7 μm. One example of suitable instrumentation is the SCANCO system model 50 microCT scanner (Scanco Medical AG, Brüttisellen, Switzerland) operated with the following settings: energy level of 45 kVp at 133 μA; 3000 projections; 35 mm field of view; 750 ms integration time; an averaging of 4; and a voxel size of 7 μm.

Test samples to be analyzed are prepared by cutting a line from one sealed edge to the other to form a triangle approx. 20 mm below the tip where the two intact sealed edges meet and the resulting cut face is approx. 28 mm in length. The prepared samples are laid flat between annuli of a low-attenuating sample preparation mounting foam, in alternating layers and mounted in a 35 mm diameter plastic cylindrical tube for scanning Scans of the samples are acquired such that the entire volume of all the mounted cut sample is included in the dataset.

In order to reliably and repeatedly measure the volume percentage of fibers, particles and void space within the sample, a small subvolume of the sample is extracted from the cross section of the product that creates a 3D slab of data, where the particles, fibers and void spaces can be qualitatively assessed. A mask that encompasses this volume of data is created. The mask should not contain void elements exterior to the product which would bias the void volume measurement. In addition, the region of the product which is chosen for analysis is based on fixed distances from physical landmarks on the product.

In order to separate the interior of the volume into three regions: 1) Particles 2) Fibers and 3) Void space, an automated thresholding algorithm is utilized which provides optimal separation of these three regions. Since the particles are higher density than the fibers, an additional step of a slight dilation of the segmented particles should also be performed. This will allow for the expected partial volume averaging at the surface of the particles to be accounted for. The dilated segmented particles can then have their total volume calculated. A lower threshold is then used to separate the fibers from the air. The fiber volume is the intersection of those voxels above the lower threshold and not part of the particle region. Lastly the void volume is then found by subtracting the overall mask volume from the union of the fiber and particle volumes.

One implementation of this is done through the use of two software platforms: Avizo 9.2.0 and Matlab R2016b, both running on Windows 64 bit workstation. In this case the data was collected from a Scanco mCT50 3D x-ray microCT scanner, collecting data at a resolution of 7 micron voxels. After the scanning and imaging reconstruction is complete, the scanner creates a 16 bit data set, referred to as an ISQ file, where grey levels reflect changes in x-ray attenuation, which in turn relates to material density. In this case, the ISQ is quite large with dimensions of 5038×5038×1326.

The ISQ file is read into Avizo 9.2.0. It is converted to 8 bit using a scaling factor of 0.15. A sub-volume is chosen that is diagonal to one corner offset by 11 mm A slab of thickness 3.5 mm is chosen for analysis.

In order to apply a robust automated thresholding scheme, a cross sectional slice from each of the three samples is read into Matlab R2016B. A function called ‘multithresh( )’ is then used to divide the segment into N different regions, where in this example N=2. This function is based on a well-known algorithm called ‘Otsu's Method’, which provides optimal segmentation based on the distribution of the image histogram. The average values of these thresholds across the three samples was then chosen. In this example, the threshold separating particles from fibers was 124 and the threshold separating fibers from air was 48. An additional dilation using a spherical structuring element of Radius 1 is used on the segmented particle data to compensate for partial volume averaging. The histogram function in Avizo then allows for the calculation of total volume associated for the fibers and particles and the total mask volume. The void volume is then found from the subtraction of fiber and particle volume from the total mask volume. These results can then be transferred into Excel for further analysis or visualization.

### Wash Residue Test Method

The Wash Residue Test qualitatively measures detergent residues on fabrics. Each test includes four comparative product samples and each product sample has four repetitions. The test uses a Whirlpool Duet washing machine (Model #WFW 9200 SQO2) connected with a water temperature control system set to 50° F.+/−1° F.

Black velvet pouches are supplied from Equest U.K. tel. (01207) 529920.
1. Material source: Denholme Velvets, Halifax Road, Denholme, Bradford, West Yorkshire, England BD13 4EZ—tel. (01274) 832 646.
2. Material type: 150 cm C.R. Cotton Pile Velvet, quality 8897, black, 72% Cotton, 28% Modal.
3. Sewing instructions for Equest: A rectangle of black velvet of 23.5 cm×47 cm is cut. The rectangle of black velvet is folded to make a square with the velvet on the inside. An overlock stitch is used and the square is sewn along two sides leaving one open edge. A blank identification label (flat cotton of 3×3 cm) is sewn into one side.
   Test preparation:
1. The pouch is turned inside out so that the velvet is on the outside with one open edge.
2. The product code and internal/external replicates are written in permanent marker on the identification label.
3. The recommended dosage for the water-soluble unit dose product for normal/median soil and normal/median water hardness is placed in the right back corner of the black velvet pouch.
4. The open end of the black pouch is folded with a seam of 2 cm and closed up with stitches in the middle of the 2 cm width seam along the whole length of the opening.
5. These steps are repeated to have 4 replicates per test product in total.
6. The black pouch is placed in the washing machine and washed as follows.

### Washing of Black Pouches:

The 4 black velvet pouches are arranged overlapping each other in such a way that the water-soluble unit dose products are all next to each other, as shown in FIG. 6, in alternating order. The arranged pouches are placed at the back of the drum.

The washing machine is turned on and set to at delicate wash program, using mixed water at 50° F.+/−1° F. (via the water temperature control system) and 6 gpg hardness, no additional ballast load is added. The washing machine runs through the entire wash cycle. At end of the washing cycle, the pouches are removed from the washing machine and opened along three sides—all except the folded side—to ensure not spilling any residues.

The pouches are graded immediately after opening. The grades from two independent graders are recorded. The data is analyzed as a Latin Square design and the analysis incorporates washing machine and product position into the statistical model. Least square means and 95% upper confidence intervals are constructed. A water-soluble unit dose product is considered to have passed the test if a 95% one-sided upper confidence interval about the mean scale unit is less than 1.

Grading is made by visual observation of the residue remaining in/on the bag after the wash. The black pouches are graded according to the following qualitative scale:
0=no residues
0.5=very small spot of maximum 1 cm diameter
1=maximum 3 small, spread spots of maximum 2 cm diameter each, spots are flat (i.e., film-like) and translucent
2=more than 3 small spots of 2 cm diameter each up to the entire black pouch is covered with flat translucent residue
2.5=small opaque residue (i.e., gel-like) less than 1 cm diameter.
3=opaque residue (e.g., gel-like) with a diameter between 1 cm and 2 cm
4=opaque residue (e.g., gel-like) with diameter between 3 cm and 4 cm diameter
5=thick, gel-like residue with diameter between 4-6 cm diameter
6=thick, gel-like residue with diameter >6 cm diameter
7=product is substantially not dissolved; residue is soft and gel-like
8=product is substantially not dissolved; residue is hard and elastic (feels like silicone);

Grade 8 is special as it indicates that the product may have been contaminated.

### EXAMPLES

### Example 1

As illustrated in FIG. 3, a first layer of fibrous elements is spun using a first spinning beam and collected on a forming belt. The forming belt having the first layer of fibers then passes under a second spinning beam that is modified with a particle addition system. The particle addition system is capable of substantially injecting particles toward a landing zone on the forming belt that is directly under the fibrous elements from the second spinning beam. Suitable particle addition systems may be assembled from a particle feeder, such as a vibratory, belt or screw feeder, and an injection system, such as an air knife or other fluidized conveying system. In order to aid in a consistent distribution of particles in the cross direction, the particles are preferably fed across about the same width as the spinning die to ensure particles are delivered across the full width of the composite structure. Preferably, the particle feeder is completely enclosed with the exception of the exit to minimize disruption of the particle feed. The co-impingement of particles and fibrous elements on the forming belt under the second spinning beam creates a composite structure where the particle packing is dilated and fibers substantially inter-penetrate the inter-particle porosity.

Table 1 below sets forth non-limiting examples of dried fiber compositions of the present invention, which is used to make the fibrous elements. To make the fibrous elements, an aqueous solution, preferably having about 45% to 60% solids content, is processed through one or more spinning beams as shown in FIG. 3. A suitable spinning beam comprises a capillary die with attenuation airflow, along with drying airflow suitable to substantially dry the attenuated fibers before their impingement on the forming belt.

TABLE 1
Fiber (F) Compositions, mass %:

| Component | F1 | F2 | F3 | F4 | F5 | F6 |
|---|---|---|---|---|---|---|
| LAS | 48.5 | 43.1 | 59.2 | 21.0 | 47.2 | 51.8 |
| AS | 0.0 | 21.6 | 0.0 | 42.0 | 23.6 | 12.9 |
| AES | 16.2 | 0.0 | 0.0 | 0.0 | 0.0 | 0.0 |
| PEG-PVAc | 0.0 | 0.0 | 5.9 | 3.2 | 0.0 | 0.0 |
| PVOH | 32.3 | 29.3 | 28.5 | 27.5 | 23.7 | 29.3 |
| PEO | 0.0 | 3.0 | 3.2 | 3.2 | 2.5 | 3.0 |
| Moist + misc. | 3.0 | 3.0 | 3.2 | 3.1 | 3.0 | 3.0 |
| Total | 100 | 100 | 100 | 100 | 100 | 100 |

Table 2 below sets forth non-limiting examples of a particle compositions of the present invention. Particles may be made by a variety of suitable processes including milling, spray-drying, agglomeration, extrusion, prilling, encapsulation, pastillization and any combination thereof. One or more particles may be mixed together before adding.

TABLE 2
Particle (P) Compositions, mass %:

| Component | P1 | P2 | P3 | P4 | P5 | P6 | P7 | P8 | P9 | P10 | P11 |
|---|---|---|---|---|---|---|---|---|---|---|---|
| LAS | 0.0 | 0.0 | 7.6 | 9.5 | 8.1 | 10.8 | 4.4 | 17.2 | 13.7 | 19.2 | 20.8 |
| AS | 19.2 | 0.0 | 0.0 | 0.0 | 0.0 | 0.0 | 0.0 | 0.0 | 0.0 | 0.0 | 1.1 |
| AES | 4.8 | 45.0 | 26.4 | 21.6 | 24.6 | 21.6 | 26.3 | 34.3 | 27.4 | 25.7 | 26.6 |
| Sodium Carb. | 18.0 | 35.0 | 19.2 | 15.3 | 15.1 | 10.0 | 14.2 | 21.6 | 21.7 | 20.6 | 22.2 |
| Zeolite-A | 54.2 | 0.0 | 24.4 | 32.0 | 49.1 | 51.8 | 49.9 | 0.0 | 0.0 | 0.0 | 0.0 |
| Chelant | 0.0 | 0.0 | 0.0 | 0.0 | 0.0 | 0.0 | 0.0 | 0.0 | 0.0 | 3.5 | 0.0 |
| PE20 | 0.0 | 0.0 | 10.4 | 3.7 | 0.0 | 3.5 | 0.0 | 3.5 | 1.6 | 3.4 | 3.4 |
| Pluronic F38 | 0.0 | 0.0 | 0.0 | 0.0 | 0.0 | 0.0 | 1.8 | 0.0 | 0.0 | 0.0 | 0.0 |
| Disp. Polymer | 0.0 | 0.0 | 0.0 | 0.0 | 0.0 | 0.0 | 0.0 | 0.0 | 16.5 | 8.1 | 8.4 |
| PEG4k | 0.8 | 0.0 | 0.0 | 8.2 | 0.0 | 0.0 | 0.0 | 0.0 | 0.0 | 0.0 | 0.0 |
| Silica | 0.0 | 15.0 | 8.2 | 6.7 | 0.0 | 0.0 | 0.0 | 20.2 | 14.5 | 16.4 | 12.3 |
| PVOH + PEO | 0.0 | 0.0 | 0.0 | 0.0 | 0.0 | 0.0 | 0.0 | 0.0 | 0.0 | 0.0 | 1.7 |
| Moist + misc. | 3.0 | 5.0 | 3.8 | 3.0 | 3.1 | 2.3 | 3.3 | 3.2 | 4.6 | 3.1 | 3.5 |
| Total | 100 | 100 | 100 | 100 | 100 | 100 | 100 | 100 | 100 | 100 | 100 |

Resulting products are exemplified in Table 3, providing structural detail for product chasses by fiber and particle components (from Tables 1 and 2, respectively), with the net chassis composition for the product. Note that other product adjunct materials such as perfume, enzymes, suds suppressor, bleaching agents, etc. may be added to a chassis.

Wash Residue Test Grades are shown for each chassis. Chasses exemplify a range of detergent products having a significant proportion of ethoxylated anionic surfactant (AES).

TABLE 3
Product Chasses (C)

| | Chassis | | | | | | | | | |
|---|---|---|---|---|---|---|---|---|---|---|
| | C1 | C2 | C3 | C4 | C5 | C6 | C7 | C8 | C9 | C10 |
| Fiber type | F1 | F2 | F2 | F2 | F2 | F2 | F2 | F2 | F6 | F2 |
| Fiber wt % | 25% | 25% | 25% | 28% | 17% | 27% | 26% | 21% | 22% | 27% |
| Particle type | P1 | P1 | P2 | P3 | P3 | P4 | P5 | P6 | P7 | P8 |
| Particle wt % | 75% | 75% | 75% | 72% | 83% | 73% | 74% | 79% | 78% | 73% |
| Basis wt, gsm | 3103 | 3104 | 2125 | 2477 | 4070 | 2900 | 2580 | 2706 | 3047 | 2900 |
| Formula, g/dose: | | | | | | | | | | |
| LAS | 2.5 | 2.2 | 1.5 | 3.0 | 3.6 | 3.6 | 2.9 | 3.1 | 3.0 | 4.2 |
| AS | 2.5 | 3.6 | 0.8 | 1.0 | 1.0 | 1.1 | 1.0 | 0.8 | 1.0 | 1.1 |
| AES | 2.0 | 1.2 | 4.7 | 3.0 | 5.9 | 3.0 | 3.1 | 3.1 | 3.7 | 3.8 |
| Sodium Carb. | 2.8 | 2.8 | 3.7 | 2.1 | 4.3 | 2.1 | 1.9 | 1.4 | 1.4 | 3.0 |
| Zeolite-A | 8.4 | 8.4 | 0.0 | 2.8 | 5.5 | 4.5 | 6.2 | 7.5 | 7.5 | 0.0 |
| Silica | 0.0 | 0.0 | 1.6 | 1.0 | 2.0 | 1.0 | 0.0 | 0.0 | 0.0 | 2.3 |
| PEG4k | 0.1 | 0.1 | 0.0 | 0.0 | 0.0 | 1.1 | 0.0 | 0.0 | 0.0 | 0.0 |
| PE20 | 0.0 | 0.0 | 0.0 | 1.5 | 2.3 | 0.5 | 0.0 | 0.3 | 0.0 | 0.2 |
| Pluronic F38 | 0.0 | 0.0 | 0.0 | 0.0 | 0.0 | 0.0 | 0.0 | 0.0 | 0.3 | 0.0 |
| Disp polymer | 0.0 | 0.0 | 0.0 | 0.0 | 0.0 | 0.0 | 0.0 | 0.0 | 0.0 | 2.3 |
| PVOH + PEO | 1.7 | 1.7 | 1.1 | 1.5 | 1.4 | 1.7 | 1.4 | 1.2 | 1.5 | 1.7 |
| moist & misc | 0.5 | 0.5 | 0.6 | 0.5 | 0.8 | 0.5 | 0.5 | 0.4 | 0.6 | 0.5 |
| Total chassis | 20.5 | 20.5 | 14.0 | 16.4 | 26.8 | 19.1 | 17.0 | 17.8 | 19.0 | 19.1 |
| Residue Test | Fail | Pass | Fail | Pass | Pass | Fail | Pass | Pass | Pass | Fail |
| Mean grade | 6.5 | 0.7 | 5.2 | 0.3 | 0.0 | 3.6 | 0.0 | 0.0 | 0.8 | 1.6 |
| Stdev | 2.8 | 0.8 | 1.7 | 0.6 | 0.0 | 0.9 | 0.0 | 0.0 | 1.5 | 1.1 |

Raw Materials for Example 1
LAS is linear alkylbenzenesulfonate having an average aliphatic carbon chain length C₁₁-C₁₂ supplied by Stepan, Northfield, Ill., USA or Huntsman Corp. HLAS is acid form.
AES is C₁₂₋₁₄ alkylethoxy (3) sulfate, C₁₄₋₁₅ alkylethoxy (2.5) sulfate, or C₁₂₋₁₅ alkylethoxy (1.8) sulfate, supplied by Stepan, Northfield, Ill., USA or Shell Chemicals, Houston, Tex., USA.
AS is a C₁₂₋₁₄ sulfate, supplied by Stepan, Northfield, Ill., USA, and/or a mid-branched alkyl sulfate.
Dispersant Polymer (Disp. Polymer) is molecular weight 70,000 and acrylate:maleate ratio 70:30, supplied by BASF, Ludwigshafen, Germany
PEG-PVAc polymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units. Available from BASF (Ludwigshafen, Germany)
Ethoxylated Polyethylenimine (PE20) is a 600 g/mol molecular weight polyethylenimine core with 20 ethoxylate groups per —NH. Available from BASF (Ludwigshafen, Germany).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

For clarity purposes, the total “% wt” values do not exceed 100% wt.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular examples and/or embodiments of the present invention have been illustrated, and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble unit dose article comprising a water-soluble fibrous structure and a plurality of particles distributed throughout the structure, wherein the water-soluble fibrous structure comprises a plurality of fibrous elements and each fibrous element comprises at least one filament-forming material and a first surfactant, wherein said first surfactant is characterized by a Hydrophilic Index (HI) of no more than about 7.5; wherein each of said particles comprises a second surfactant, wherein said second surfactant is characterized by a HI of greater than 7.5.

2. The water-soluble unit dose article of claim 1, wherein the first surfactant is selected from the group consisting of unalkoxylated C6-C20 linear or branched alkyl sulfates (AS), C6-C20 linear alkylbenzene sulfonates (LAS), and combinations thereof, preferably C6-C20 linear alkylbenzene sulfonates (LAS).

3. The water-soluble unit dose article of claim 1, wherein the second surfactant is selected from the group consisting of C6-C20 linear or branched alkylalkoxylated sulfates (AAS) having a weight average degree of alkoxylation ranging from 0.1 to 10, C6-C20 alkylalkoxylated alcohols (AA) having a weight average degree of alkoxylation ranging from 5 to 15, and combinations thereof.

4. The water-soluble unit dose article of claim 1, wherein the first surfactant is present as the main surfactant in each of the fibrous elements, and wherein preferably the second surfactant is present as the main surfactant in each of the particles.

5. The water-soluble unit dose article of claim 1 wherein each of the particles comprises from about 5% to about 60% by weight of the particle of the second surfactant.

6. The water-soluble unit dose article of claim 1 wherein each fibrous element comprises from about 10% to about 90% by weight, preferably from about 20% to about 80% by weight, more preferably from about 30% to about 70% by weight on a dry fibrous element basis of the first surfactant.

7. The water-soluble unit dose article according to claim 1 wherein said water-soluble unit dose article further comprises at least one particle comprising an active agent selected from the group consisting of a structurant, a builder, a polymeric dispersing agent, an enzyme, an enzyme stabilizer, a bleach system, a brightener, a hueing agent, a chelating agent, a suds suppressor, a conditioning agent, a humectant, a perfume, a perfume microcapsule, a filler or carrier, an alkalinity system, a pH control system, a buffer, an alkanolamine, a mosquito repellant, and mixtures thereof.

8. The water-soluble unit dose article according to claim 1 wherein said water-soluble unit dose article further comprises at least one particle comprising one or more water-insoluble materials.

9. The water-dispersible unit dose article of claim 8 wherein said insoluble material is dispersible to a suspension mean particle size of less than about 20 microns, or less than about 50 microns.

10. The water-soluble unit dose article according to claim 1 wherein said particles have a D50 particle size of from about 150 μm to about 1600 μm as measured according to the Granular Size Distribution Test Method.

11. The water-soluble unit dose article according to claim 1 wherein said fibrous elements are filaments, fibers, or a mixture thereof, preferably said fibrous elements are filaments.

12. The water-soluble unit dose article according to claim 1 wherein said filament-forming material comprises a polymer, preferably said polymer is selected from the group consisting of polyvinyl alcohols, polyalkylene glycols, starch or modified starch, cellulose or modified cellulose, polyacrylates, polymethacrylates, polyacrylamides, polyvinylpyrrolidones, and combinations thereof; and wherein more preferably said water-soluble polymer is selected from the group consisting of polyvinyl alcohols, polyalkylene glycols, and combinations thereof.

13. The water-soluble unit dose article according to claim 1, wherein each of said fibrous elements comprises from about 0% to about 15%, preferably from about 0% to about 10%, more preferably from about 0% to about 5%, most preferably from about 0% to about 1% of the second surfactant, by weight on a dry fibrous element basis.

14. The water-soluble unit dose article according to claim 1, wherein the second surfactant is a C6-C20 linear or branched AAS surfactant having a weight average degree of alkoxylation ranging from 0.1 to 10, preferably a C10-C16 linear or branched alkylethoxylated sulfate (AES) having a weight average degree of alkoxylation ranging from 1 to 5.

15. The water-soluble unit dose article of claim 14, wherein each of said particles further comprises from 0.5% to 20%, preferably from 1% to 15%, more preferably from 2% to 10% by total weight of said each discrete particle of a rheology modifier selected from the group consisting of an alkoxylated polyalkyleneimine, an ethylene oxide-propylene oxide-ethylene oxide (EOx₁POyEOx₂) triblock copolymer wherein each of x₁ and x₂ is in the range of about 2 to about 140, preferably about 2 to about 100, more preferably about 2 to about 80, and y is in the range of from about 15 to about 70, N,N,N′,N′-tetra(2-hydroxyethyl)ethylenediamine, and mixtures thereof, wherein preferably said alkoxylated polyalkyleneimine has an empirical formula of (PEI)a(CH2CH2O)b(CH2CH2CH2O)c, wherein PEI is a polyethyleneimine core; wherein a is the number average molecular weight (MWn) of the PEI core prior to modification, which ranges from 100 to 100,000 Daltons, preferably from 200 to 5000 Daltons, more preferably from 500 to 1000 Daltons; wherein b is the weight average number of ethylene oxide (CH2CH2O) units per nitrogen atom in the PEI core, which ranges from 0 to 60, preferably from 1 to 50, more preferably from 5 to 40, most preferably from 10 to 30; and wherein c is the weight average number of propylene oxide (CH2CH2CH2O) units per nitrogen atom in the PEI core, which ranges from 0 to 60, preferably from 0 to 40, more preferably from 0 to 30, most preferably from 0 to 20.

16. The water-soluble unit dose article of claim 14, wherein each of said particles further comprises 0.5% to 20%, preferably from 1% to 15%, more preferably from 2% to 10%, of a polyalkylene glycol, by total weight of said each discrete particle, wherein said polyalkylene glycol is preferably a polyethylene glycol with a weight average molecular weight ranging from 500 to 20,000 Daltons, preferably from about 1000 to 15,000 Daltons, and more preferably from 2000 to 5000 Daltons.

17. The water-soluble unit dose article according to claim 1 wherein said water-soluble unit dose article exhibits a Wash Residue Test grade of less than or equal to about 1.0 as measured according to the Wash Residue Test Method.

18. The water-soluble unit dose article according to claim 1 wherein said water-soluble unit-dose article has a Basis Weight of from about 500 grams/m2 to about 5,000 grams/m2, preferably from about 1,000 grams/m2 to about 4,000 grams/m2, more preferably from about 1,500 grams/m2 to about 3,500 grams/m2, even more preferably from about 2,000 grams/m2 to about 3,000 grams/m2, as measured according to the Basis Weight Test Method described herein.
